(19) United States
(12) Patent Application Publication
(10) Pub. No.: US 2026/0037714 A1
(43) Pub. Date: Feb. 5, 2026

(54) METHODS AND DEVICES FOR PROVIDING SELECTABLE AND EDITABLE DYSLEXIC-FRIENDLY READABLE IMAGES

(71) Applicants: Hillary Patience Summerbell, Lewes, DE (US); Jeremy Dunsworth, Seattle, WA (US)

(72) Inventors: Hillary Patience Summerbell, Lewes, DE (US); Jeremy Dunsworth, Seattle, WA (US)

(21) Appl. No.: 19/340,287

(22) Filed: Sep. 25, 2025

Related U.S. Application Data
(63) Continuation-in-part of application No. 19/184,125, filed on Apr. 21, 2025.
Application No. 19/184,125 is a continuation of application No. 17/062,541, filed on Oct. 2, 2020, now Pat. No. 12,282,726.
(60) Provisional application No. 62/988,729, filed on Mar. 12, 2020.
(60) Provisional application No. 63/074,484, filed on Sep. 4, 2020.
(60) Provisional application No. 63/080,714, filed on Sep. 19, 2020.

(51) Int. Cl. G06F 40/103; G06F 40/166

(52) U.S. Cl. CPC G06F 40/103; G06F 40/166

(57) ABSTRACT

Dyslexic-friendly, readable images are generated from linear formatted images. Each dyslexic-friendly, readable image may include one or more positioned, non-linear (e.g., curved) boundaries and a plurality of textual objects, where each object is positioned at a distance from the boundaries and follows a boundary. The dyslexic-friendly, readable images can be edited by the user personally and manipulated using AI.

### INTRODUCTION

The present application is a continuation-in-part of pending U.S. Ser. No. 19/184,125 filed Apr. 21, 2025 (the “'125 application”), which is a continuation of U.S. Ser. No. 17/062,541 filed Oct. 2, 2020, now U.S. Pat. No. 12,282,726 (the “'541 application”), which claims the benefit of priority to U.S. provisional application 62/988,729 filed Mar. 12, 2020 (the “'729 application”), U.S. Provisional Application No. 63/074,448 filed Sep. 3, 2020 (the “'448 application”), and U.S. Provisional Application 63/080,714 filed Sep. 19, 2020 (the “'714 application”). Further, the present application is related to U.S. Non-provisional application Ser. No. 16/867,388 (the “'388 application”) filed May 5, 2020. The present application incorporates by reference the entire disclosures of the '125, '541, '729, '448, '714 and '388 applications, including drawings, as if each were set forth in full herein.

### FIELD OF THE INVENTION

The present application relates to the conversion of text and other symbols into images that can be understood by individuals that have learning differences, such as dyslexia.

### BACKGROUND OF THE INVENTION

This section introduces aspects that may be helpful to facilitate a better understanding of the described invention(s). Accordingly, the statements in this section are to be read in this light and are not to be understood as admissions about what is, or what is not, in the prior art.

For an individual with learning differences, such as dyslexia, it is difficult, if not impossible, to read text (letters, words, numbers, symbols) as it is currently presented in a conventional format. For example, conventional text is displayed substantially on, or between, one or more straight, parallel horizontal lines (i.e., a “linear” format). This format is used to present text in online web sites, social media web sites, books, magazines, signs, etc. regardless of language. Even if such lines are not visible, the text is still shown spaced substantially on, or from one or more boundaries as if the lines were visible. This conventional, linear format is very difficult for a person with a learning difference because they are unable to break up words or syllables of words or text of any kind in a linear format into separate components, cannot sound out syllabic components of a word, or break up a word or a math equation in a linear format. To a person with a learning difference, words, sentences and paragraphs in a linear format many times appear as one single, combined image.

This problem exists whether the text is represented on a piece of paper, computer screen or printed page. The conventional ways and means of processing information (e.g., text) using two-dimensional, linear lines, boundaries and paragraphs adversely affect many aspects of the daily life of a person with a learning difference (e.g., dyslexic).

For example, when a dyslexic sees a word in a linear format they do not recognize or multiple lines of text, a dyslexic may go “blank” (known as “word blindness”). This word blindness may also cause the dyslexic problems with following a sequence of instructions, such as a recipe. Further, dyslexics have a hard time remembering numbers or letters in their proper sequence in a linear format, which makes performing precise math calculations very challenging to say the least.

Conservative estimates are that dyslexia alone affects 10% of the world's population, and perhaps up to 17%.

Accordingly, there is a need for better methods and systems that allow people with a learning difference, such as dyslexia, to read and understand text and other symbols.

### SUMMARY OF THE INVENTION

The inventors (one of whom is dyslexic) have discovered that providing an image in a non-linear format substantially improves the ability of a person with a learning difference, such as dyslexia, to read and comprehend the content of the image (e.g., the text or other symbol). In one embodiment, an inventive for converting linear formatted text into a dyslexic-friendly readable image using an electronic device may comprise: electronically reading or receiving linear formatted text; electronically converting the read or received, linear formatted text into the non-linear, dyslexic-friendly readable image using an electronic device, where the converted image comprises, (i) a surface or background portion; (ii) one or more positioned non-linear boundaries, and (iii) one or more textual objects, where the one or more textual objects are positioned such that each object is at a first distance from the one or more positioned non-linear boundaries. Such a first distance may be an equal distance from one or more positioned non-linear boundaries, of the one or more positioned boundaries, that are located above and below the one or more objects, or the first distance may be an equal distance from a positioned non-linear boundary, of the one or more positioned boundaries, that is located above or below the one or more objects.

Each of the one or more positioned boundaries may be separated by a second distance, and the first distance may be substantially ⅓ of the second distance.

The exemplary method may further comprise adjusting a slope of the non-linear boundaries, for example.

Further, the method may additionally comprise electronically selecting one or more objects within the non-linear, dyslexic-friendly readable image; electronically presenting a list of functional or informative indicators; electronically selecting an indicator from the list; and completing a function or displaying information associated with selected indicator.

In an additional embodiment, the method may further comprise presenting a definition of selected one or more objects.

An exemplary method may include the steps set forth above, and in addition, the steps of electronically selecting one or more objects within a non-linear, dyslexic-friendly readable image, and emphasizing the one of more selected objects, and/or de-emphasizing non-selected objects within the non-linear, dyslexic-friendly readable image.

Another exemplary method may include the steps set forth above, and in addition, the steps of displaying an edit indicator, selecting an object from one or more objects to be edited, editing the object, and visually indicating the selected object is being edited by presenting an image editing indicator.

In any of the embodiments described above, a method may comprise re-converting the non-linear, dyslexic-friendly image back to the linear formatted text.

It should be understood that the one or more objects may comprise one or more of grammatical letters, words, numbers, or symbols, where a grammatical letter, word or symbol may comprise a character in a language.

In yet another method, after linear formatted words have been typed into a computer using a keyboard, for example, these words may be converted into a non-linear image that includes positioning one or more of objects substantially in a middle of a display.

In addition to inventive methods, the inventors also provide inventive electronic devices that are operable to convert linear formatted text into a dyslexic-friendly readable image.

One such device may comprise an electronic processor that may be operable to execute stored instructions to electronically read or receive linear formatted text, and electronically convert the read or received, linear formatted text into the non-linear, dyslexic-friendly readable image, where the converted image comprises (i) a surface or background portion, (ii) one or more positioned non-linear boundaries, and (iii) one or more textual objects, where the one or more textual objects are positioned such that each object is at a first distance from the one or more positioned non-linear boundaries.

Such a first distance may be an equal distance from one or more positioned non-linear boundaries, of the one or more positioned boundaries, that are located above and below the one or more objects, or the first distance may be an equal distance from a positioned non-linear boundary, of the one or more positioned boundaries, that is located above or below the one or more objects.

Each of the one or more positioned boundaries may be separated by a second distance, and the first distance may be substantially ⅓ of the second distance.

Such an electronic processor may be further operable to execute additional stored instructions to complete one or more of the following functions and/or features: adjusting a slope of the non-linear boundaries; select one or more objects within the non-linear, dyslexic-friendly readable image, present a list of functional or informative indicators, select an indicator from the list, and complete a function or display information associated with selected indicator.

In another embodiment, an electronic processor may complete the functions described and still be further operable to execute stored instructions to present a definition of selected one or more objects.

In yet another embodiment, an electronic processor may be further operable to execute stored instructions to: select one or more objects within the non-linear, dyslexic-friendly readable image; emphasize the one of more selected objects; and/or de-emphasize non-selected objects within the non-linear, dyslexic-friendly readable image.

Other exemplary, inventive electronic processors may complete the functions described above and herein, including, for example: executing stored instructions to: display an edit indicator; select an object from the one or more objects to be edited; edit the object; and/or visually indicate a selected object is being edited by presenting an image editing indicator.

In any of the exemplary electronic devices described above or herein, such a device may include an electronic processor that is further operable to execute stored instructions to re-convert a non-linear, dyslexic-friendly image to linear formatted text.

It should be understood that the one or more objects mentioned above and herein may comprise one or more of grammatical letters, words, numbers, or symbols, where a grammatical letter, word or symbol comprises a character in a language, for example.

Still further, an exemplary electronic device may complete the functions and features described above along with the feature of including a processor that executes stored instructions in order to position one or more of textual objects substantially in a middle of a display.

It should be understood that the exemplary electronic devices can comprise smartphones, tablets, laptops, PCs, displays and other such devices. Furthermore, advanced algorithms, such as AI, can be employed.

The inventor believes that the inventive methods and devices will substantially help people with learning differences, such as dyslexics, read, spell, and comprehend information as well as help such individuals perform arithmetic.

### BRIEF DESCRIPTION OF THE DRAWINGS

FIGS. 1A to 1C depict, among other things, an exemplary inventive image provided in accordance with an embodiment of the invention.

FIGS. 2A to 2C depict, among other things, another exemplary inventive image provided in accordance with an embodiment of the invention.

FIGS. 3A to 3F depict, among other things, additional, exemplary inventive images provided in accordance with embodiments of the invention.

FIGS. 4A to 4C depict, among other things, yet further additional, exemplary inventive images provided in accordance with an embodiment of the invention.

FIG. 5A depicts a simplified block diagram of a technique for providing inventive images that presents or displays text in a non-linear format to substantially improve the ability of person with a learning difference, such as dyslexia, to read and comprehend the so presented/displayed text.

FIGS. 5B to 5D illustrate an exemplary method of converting a linear formatted image into an inventive, non-linear formatted image.

FIGS. 5E to 5L depict additional features of an inventive method according to an embodiment of the invention.

FIGS. 6A to 6C depict exemplary examples of the conversion of linear formatted images (e.g., text) into a non-linear formatted, dyslexic-friendly readable image in accordance with embodiments of the invention.

FIGS. 7A to 7I depict examples of the conversion of linear formatted images (e.g., text), that have been typed into an electronic device, into a non-linear formatted, dyslexic-friendly readable image in accordance with embodiments of the invention.

FIGS. 8-13 depict additional examples of the conversion of linear formatted images on personal devices, such as smartphones, where data or images can be selected and converted into a non-linear formatted, dyslexic-friendly readable image in accordance with embodiments of the invention.

FIG. 14 depicts another embodiment of the instant invention, implementing the conversion of linear formatted images on personal devices, such as a smartphone, where data or images can be selected and converted into a non-linear formatted, dyslexic-friendly readable image, and be easily manipulated by the user, whether using tactile actions (keystrokes, cursor) or via voice command to activate the conversion and display, such as using AI.

### DETAILED DESCRIPTION OF THE INVENTION

Exemplary embodiments for providing dyslexic-friendly readable images are described herein and are shown by way of example in the drawings. Throughout the following description and drawings, like reference numbers/characters refer to like elements. It should be understood that although specific embodiments are discussed herein, the scope of the disclosure is not limited to such embodiments. On the contrary, it should be understood that the embodiments discussed herein are for illustrative purposes, and that modified and alternative embodiments that otherwise fall within the scope of the disclosure are contemplated.

It should also be noted that one or more exemplary embodiments may be described as a process or method (the words “method” may be used interchangeably with the word “process” herein).

Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method if, for example, such steps are known by those skilled in the art.

It should be understood that when an system or device, or a component or element of a system or device, is referred to, or shown in a figure, as being “connected” to (or other tenses of connected) another system, device (or component or element of a system or device) such systems, devices, components or elements may be directly connected, or may use intervening components or elements to aid a connection. In the latter case, if the intervening systems, devices, components or elements are well known to those in the art they may not be described herein or shown in the accompanying figures for the sake of clarity.

It should also be understood that, as used herein, the designations “first”, “second”, “third”, “fourth” etc., is purely to distinguish one parameter or element from another and does not indicate a priority or order. The parameters or elements could be re-designated (i.e., re-numbered) and it would not affect the methods or devices provided by the present invention.

As used herein, the term “and/or” includes any and all combinations of one or more of the associated listed items. As used herein, the singular forms “a,” “an” and “the” are intended to include the plural form, unless the context and/or common sense indicates otherwise.

It should further be understood that the terms “comprises”, “comprising,”, “includes” and/or “including”, when used herein, specify the presence of stated features, steps, operations, elements, and/or components, but do not preclude the presence or addition of one or more other features, steps, operations, elements, components, and/or combinations thereof.

As used herein the term “operable to” means “functions to” unless the context, common sense or knowledge of one skilled in the art indicates otherwise. More particularly, when used to describe the operation of an electronic processor the phrase “operable to” may mean such a processor and its associated memory execute stored instructions to complete certain functions.

It should be understood that the phrase “processor” means one or more electronic devices (e.g., specialized programmed electronic processors) that is (are) operable to be specially programmed to retrieve and execute specific instructions stored as electronic signals in electronic memory, where a set of such stored specific instructions may constitute steps in an inventive process or method, or may be executed to complete an inventive function(s), such as completing the functions or steps of: selecting, displaying, locating, identifying, presenting, converting, re-converting, positioning, dividing, separating, reading, receiving, inputting, transmitting, reproducing, generating, communicating, creating, highlighting, boldening, emphasizing, re-emphasizing, adjusting, and varying to name just a few of the inventive functions/processes that may be completed by executing such stored electronic instructions.

Further, it should be understood that each embodiment of a processor described herein is further configured with the necessary hardware and firmware components to enable each to process stored instructions and complete inventive functions/steps in a process much faster than humanly possible. Each of the electronically-based embodiments of the present invention cannot practically be implemented in any amount of time that would be acceptable to one skilled in the art using human beings as substitutes for the electronic systems, processes and devices described herein. Accordingly, the use of humans as substitutes for such methodologies is contrary to the objectives of the invention and does not result in the improvements provided by the invention.

As used herein “dyslexic-friendly” means an inventive image that can be easily read and understood by individuals who suffer from a learning difference, such as dyslexia.

As used herein the word “text” may refer to a single grammatical letter, word or symbol, a sentence, phrase, and/or a mathematic number, symbol or operator, for example. Together a plurality of text may form a paragraph or mathematical equation, for example. Further, it should be understood that “text” that comprises a grammatical letter, word or symbol may further comprise a character in a language.

As used herein the phrases “embodiment” or “exemplary” mean a non-limiting example of the present invention. Though the embodiments described herein and shown in the figures may depict certain geometric shapes, it should be understood that these shapes are merely exemplary, and, accordingly, other shapes may be substituted for the so described and depicted shapes.

Still further, it should be understood that an electronic device that completes features and functions of embodiments of the invention may include stored instructions that form a web browser that is a part of an interface, a stored “plug-in”, or one or more applications (often referred to herein as an “APP” or “APPS”) that have been installed into, or downloaded onto, an electronic device. An “APP” or plug-in may include “content” (e.g., text, audio and video files), signaling and configuration files. For the sake of convenience and not limitation, the terms “APP” or “application” are used herein to refer to any application, but use of such a term also includes a reference to any file or data. In one embodiment, an APP to be downloaded onto a device may also reside or be stored on one or more hardware devices, such as a server in whole and/or in part, the later indicating that the APP may be distributed among, and by, a number of devices (servers). An APP may be downloaded to a user's device from an APP server (or servers as the case may be) or have been otherwise provided and installed on such a server. A given user's electronic device may have a need for one or more of the APPs installed on a server.

Accordingly, it should be understood that each of the embodiments described herein includes protocols, necessary hardware, software and firmware resident on a user device for transmitting and receiving (i.e., transceiving) an APP, content and/or content identification information relating to the APP from/to a server and vice-versa.

It should be understood that depending on the content to be transmitted, an APP may be installed directly on a user device or may be downloaded from a server by initiating a request to a server to receive a local copy of the APP. When a discussion herein describes transmissions from a user's electronic device to a server, or vice-versa, it should be understood that a web browser, plug-in and/or APP may be used to complete such transmissions and receptions.

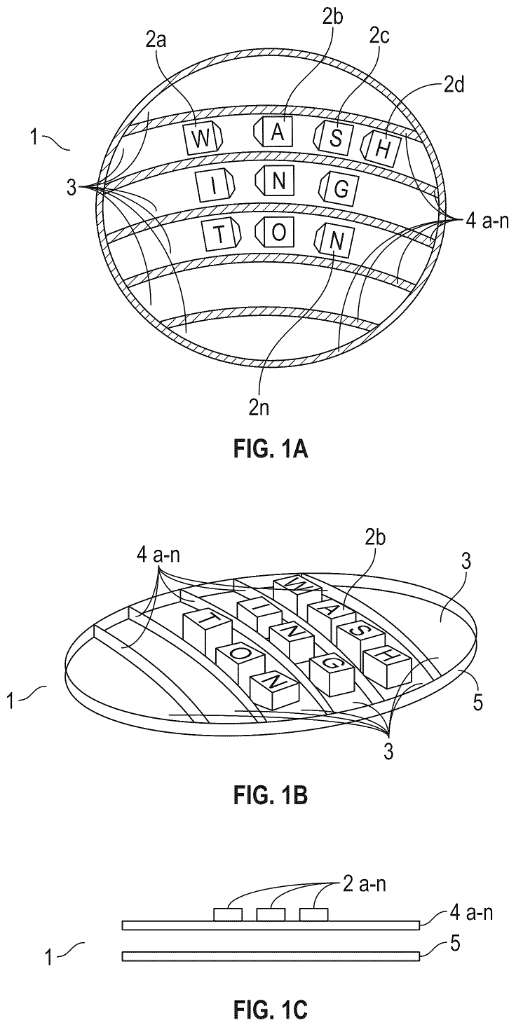

Referring now to FIGS. 1A to 1C of the DRAWINGS, there is depicted an exemplary inventive image 1 provided in accordance with an embodiment of the invention. As shown the image 1 may comprise a surface or background portion 3 with one or more positioned non-linear (i.e., curved) boundaries 4a to 4n (where “n” represents the last boundary) (e.g., non-linear lines) for dividing the image into textual locations and one or more textual objects 2a-2n (e.g., 3-dimensional text) representing text positioned on the portion such that each object is at a same first distance from the one or more positioned non-linear boundaries 4a to 4n.

As noted previously, the one or more objects 2a to 2n may comprise one or more grammatical letters, words, numbers, and symbols, for example (i.e., collectively “text”). Still further, in one embodiment, each of the objects 2a to 2n may comprise text presented in a block-lettering format. In one embodiment the first distance may comprise an equal distance from the one or more positioned non-linear boundaries 4a to 4n, that are located above and below the one or more objects 2a to 2n, to the objects 2a to 2n.

Alternatively, first distance may be an equal distance from the non-linear boundaries 4a to 4n that is located above or below the one or more objects 2a to 2n, to the objects 2a to 2n. Accordingly, the objects 2a to 2n may appear to “follow” the positioned non-linear boundaries 4a to 4n.

Because of the positioning of the textual objects, the image 1 effectively, visually separates text (e.g., a word or phrase and/or elements thereof (e.g., letters) from another word or phrase so that a person with a learning difference, such as a dyslexic, can read and understand the text represented by the image 1. As depicted in FIGS. 1A and 1B the entire image 1 may be formed as a circular or oval image. Accordingly, when the entire image is reproduced it may be reproduced as a circular or oval image. Still further, the image 1 may optionally comprise a 3D border 5 that corresponds to the geometric shape of the image 1, in this case a circular or oval shape. The border 5 may appear as a circumference or edge of the image 1.

Though the objects 2a to 2n may be a first distance from each of the one or more positioned boundaries 4a to 4n, the positioned boundaries 4a to 4n themselves may each be separated or positioned from one another by a second distance. In one embodiment, the first distance may be substantially ⅓ of the second distance.

In yet another embodiment, one or more of the one or more positioned boundaries 4a to 4n may be located above or below each of the one or more objects 2a to 2n at a third distance from each of the one or more objects 2a to 2n, while another one of the one or more positioned boundaries is located below or above the one or more objects and is at a fourth distance, where the third and fourth distances may be different from each other and may vary from a second distance by up to about 10%.

Alternatively, the third and fourth distances may be the same distance. Though the exemplary images shown in the figures depict continuous boundaries it should be understood that the boundaries may comprise one or more undulations.

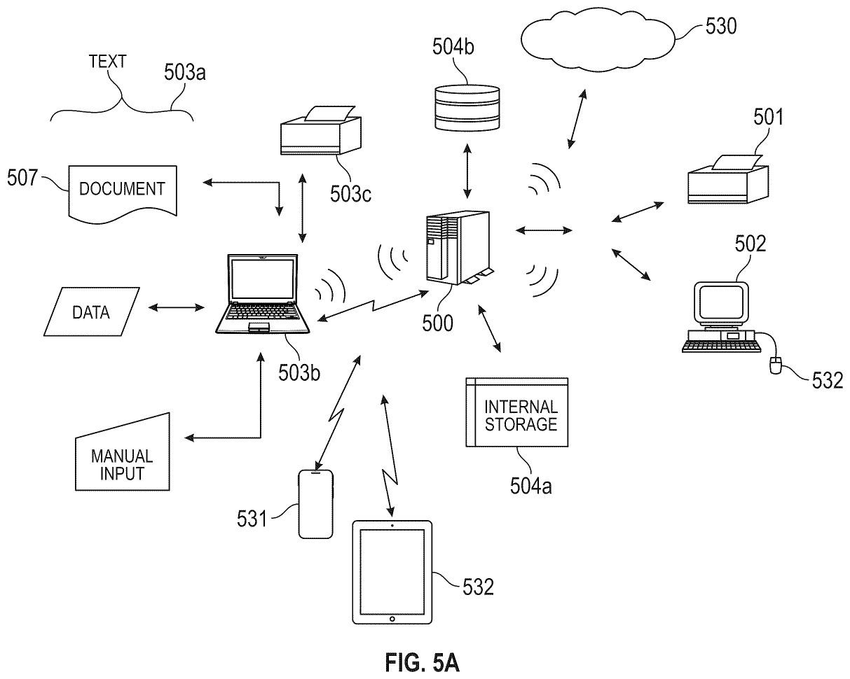

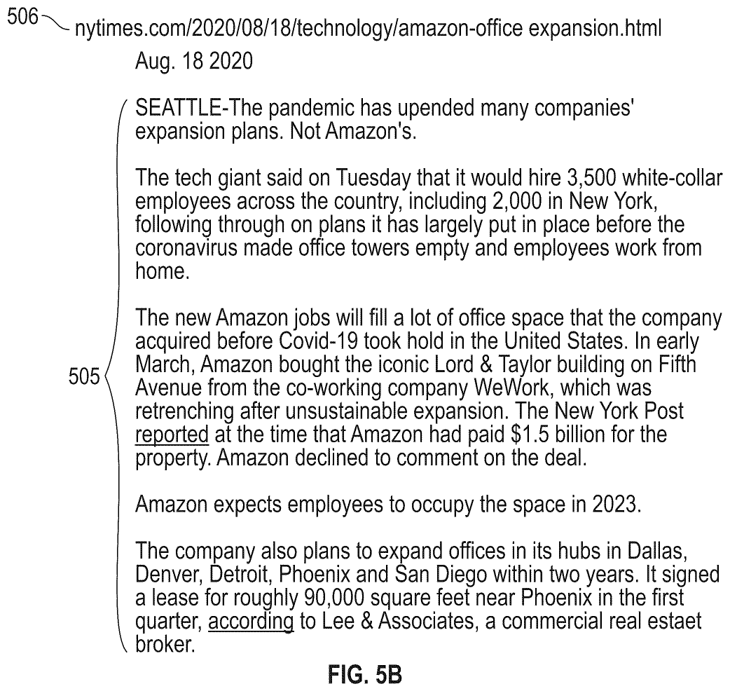

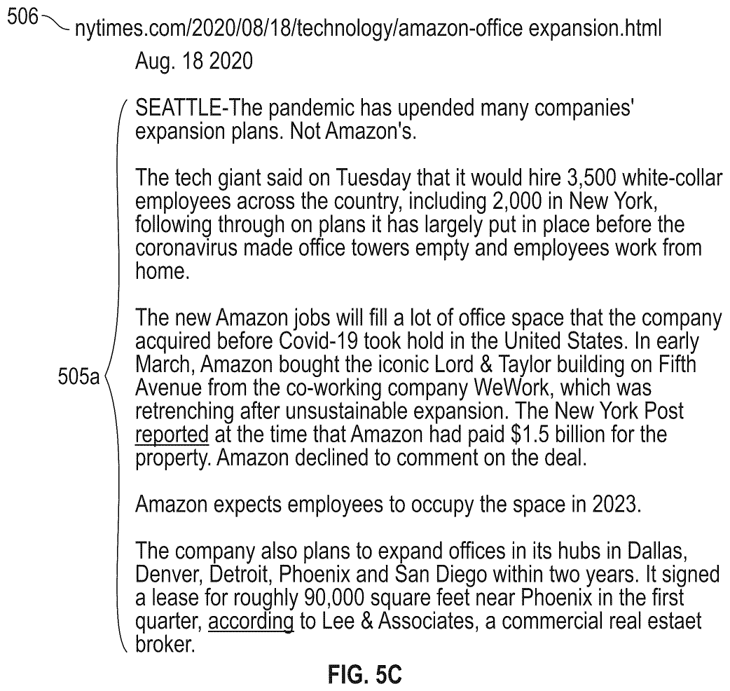

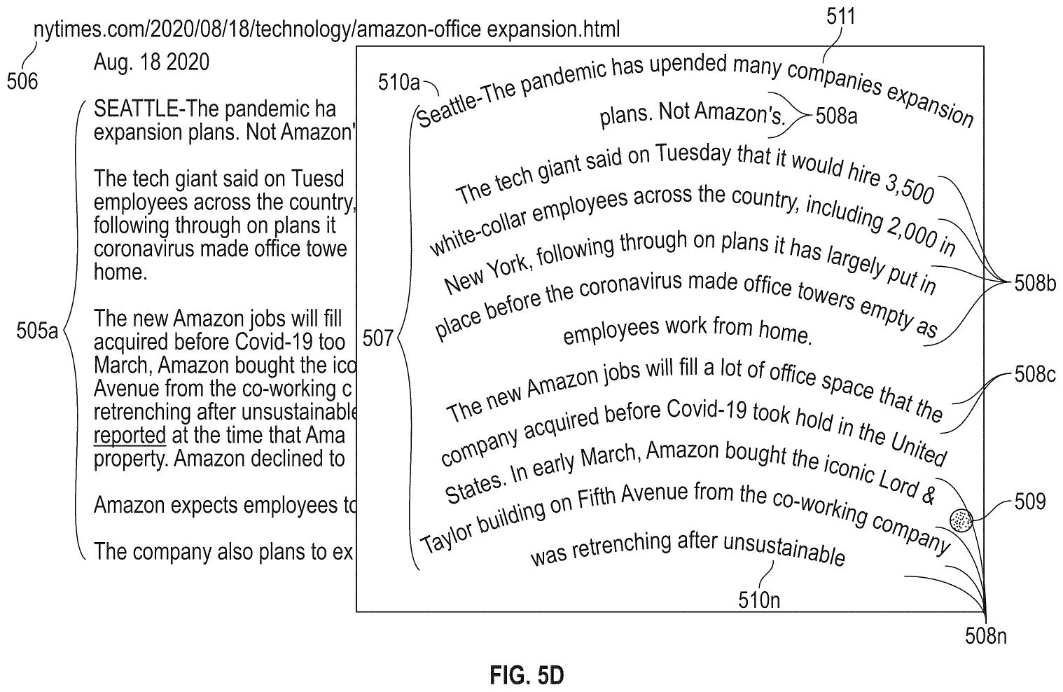

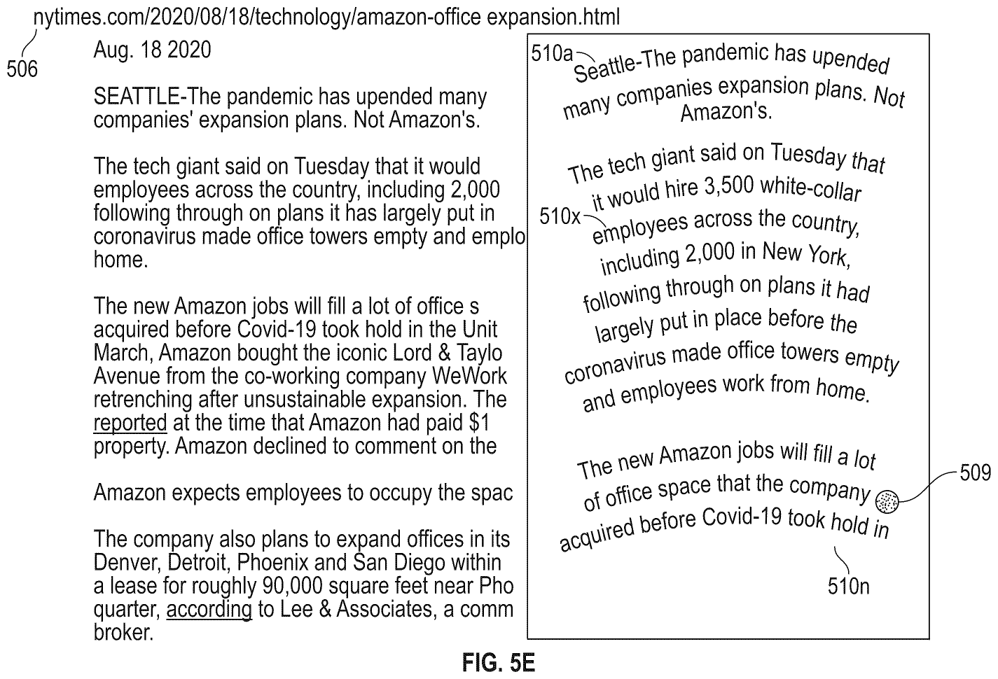

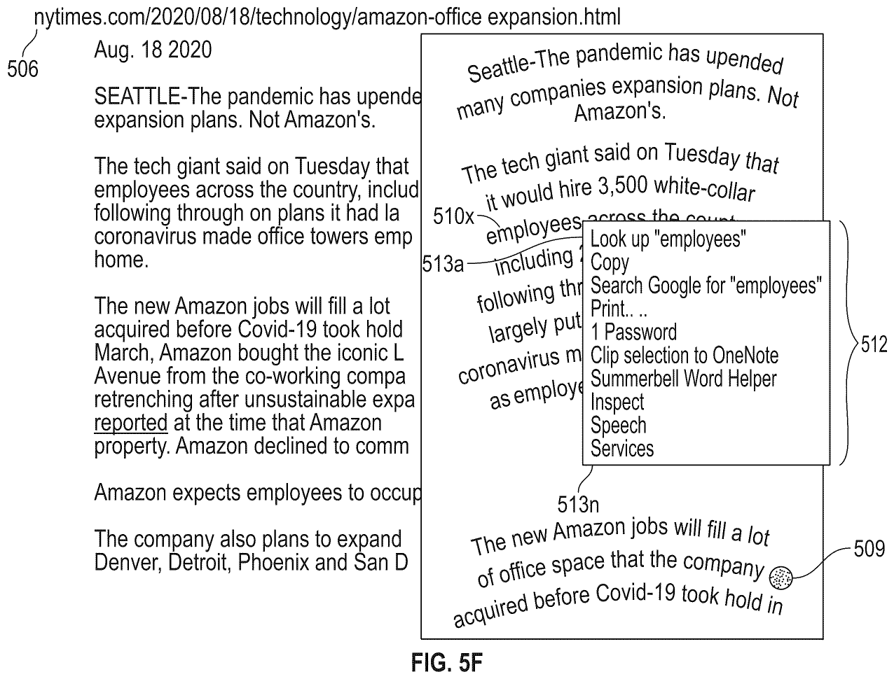

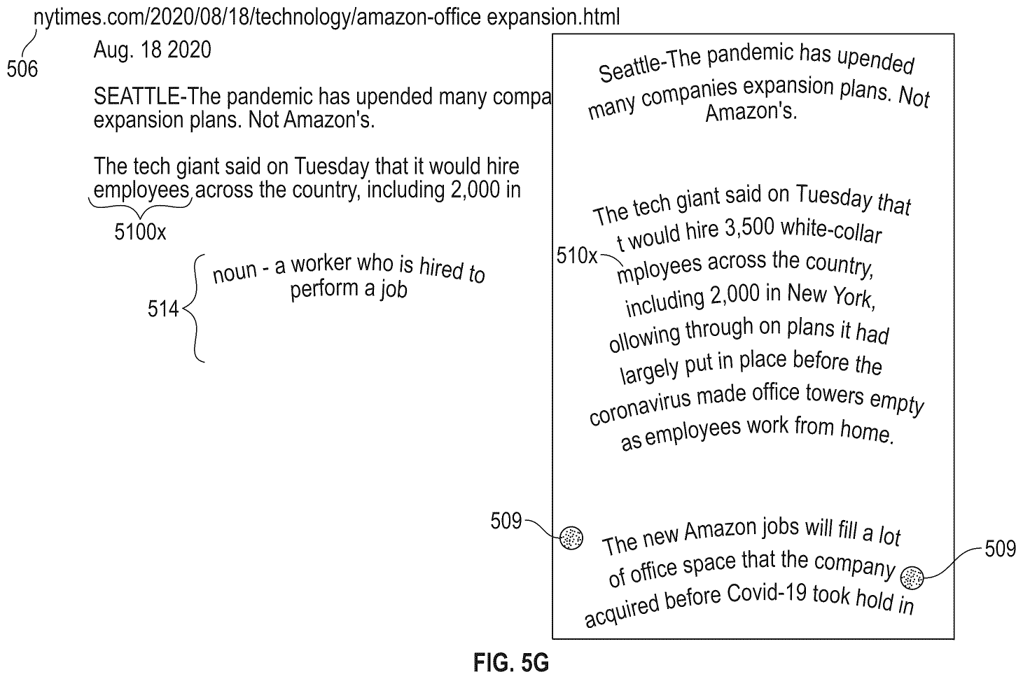

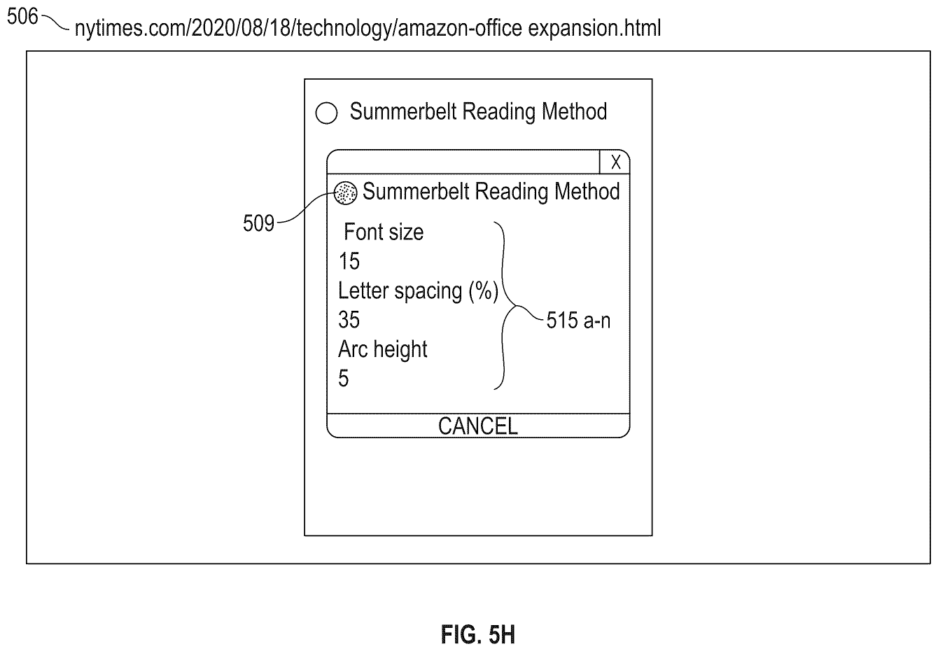

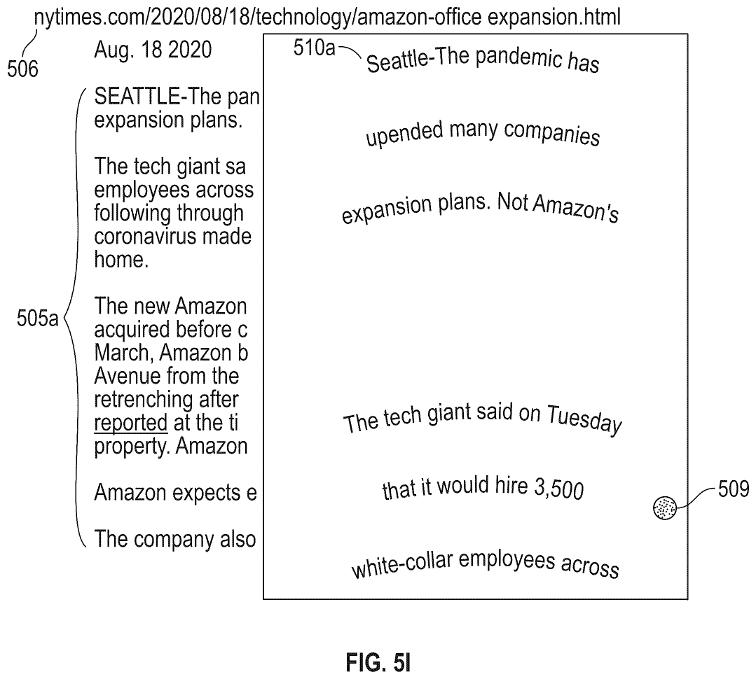

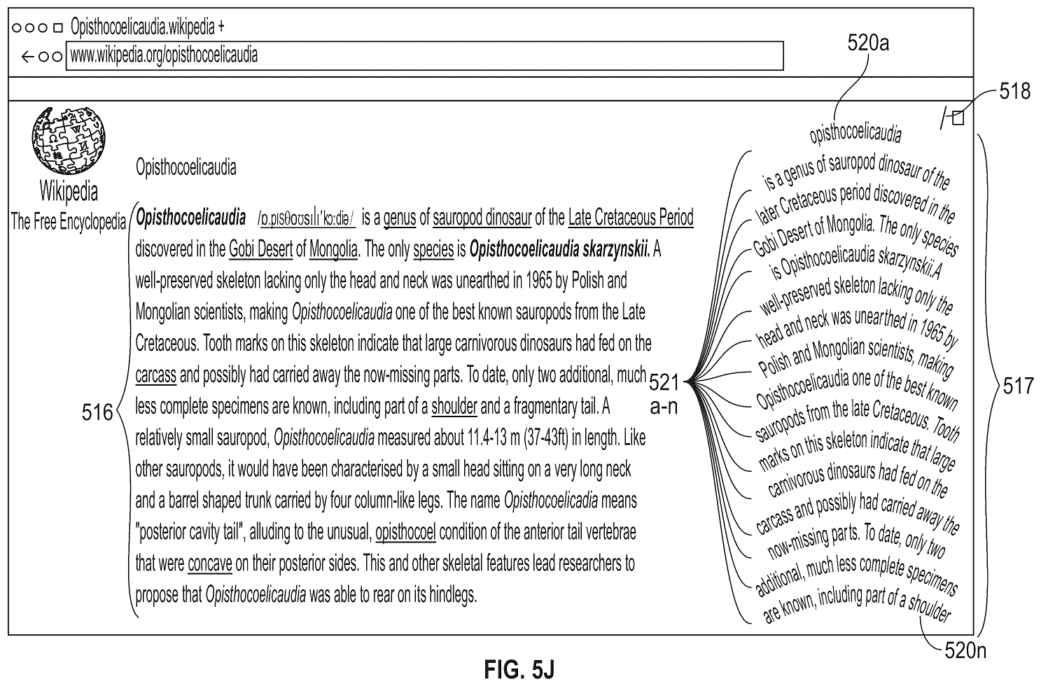

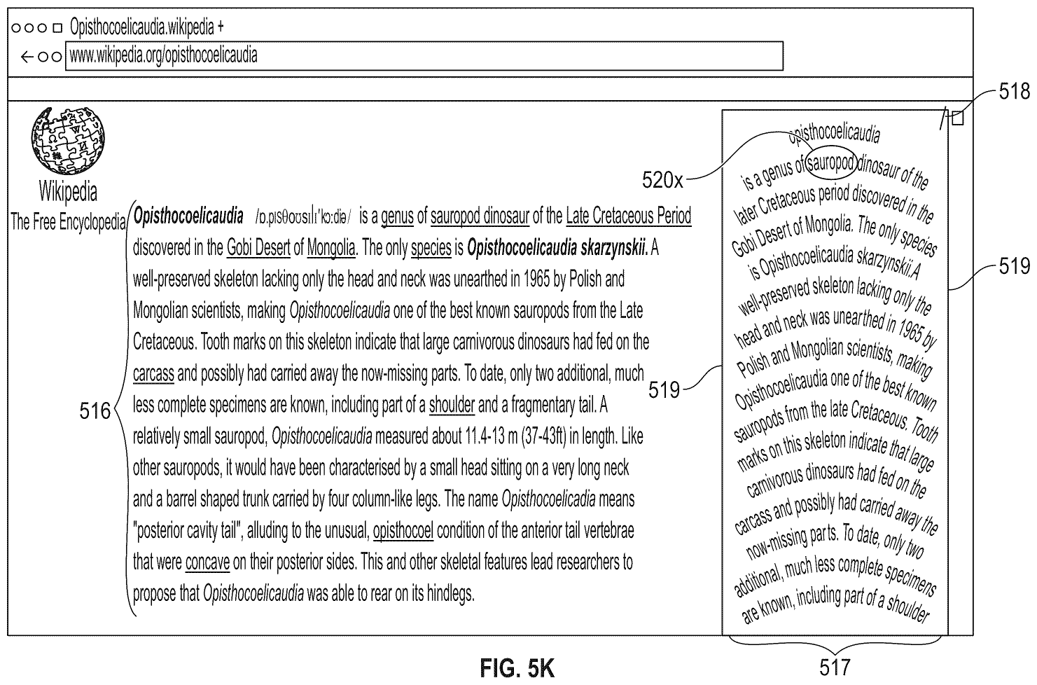

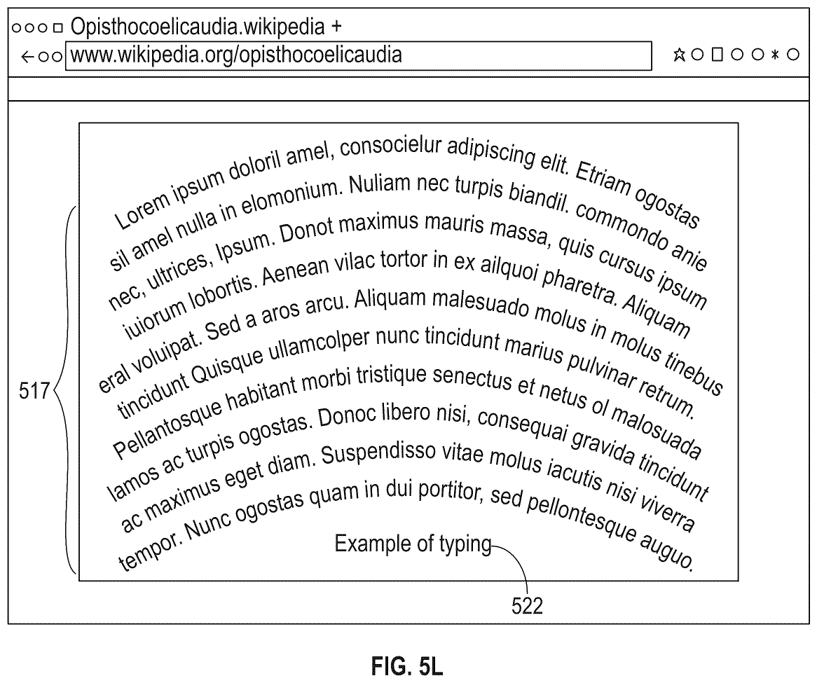

Referring now to FIG. 5A of the DRAWINGS, there is depicted a simplified block diagram of a technique for providing inventive, dyslexic-friendly readable images in a non-linear format to substantially improve the ability of a person with a learning difference, such as a dyslexic, to read and comprehend the so provided images.

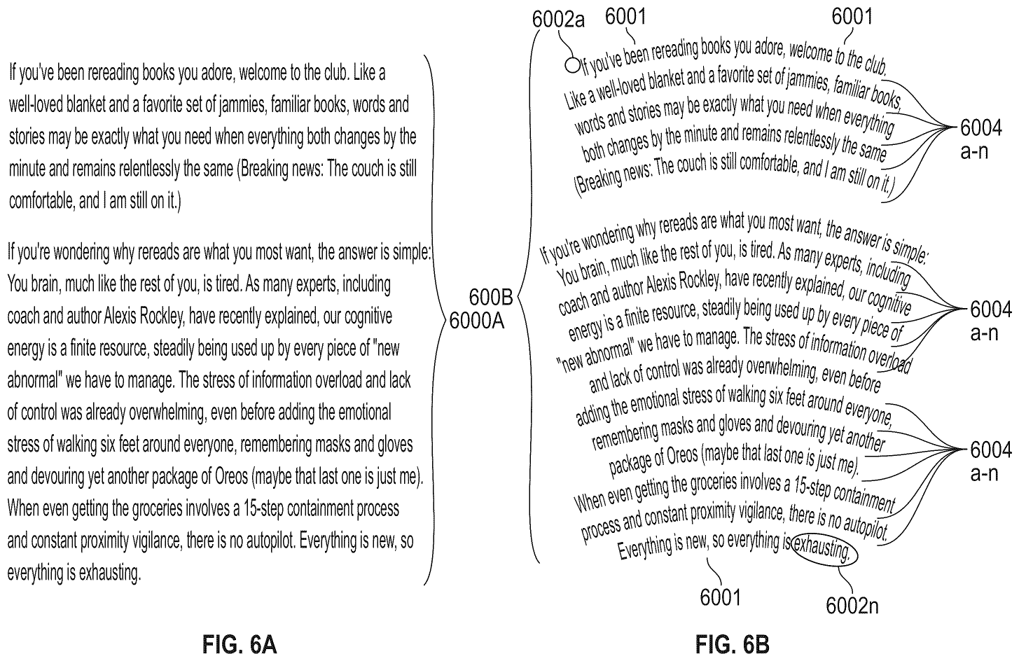

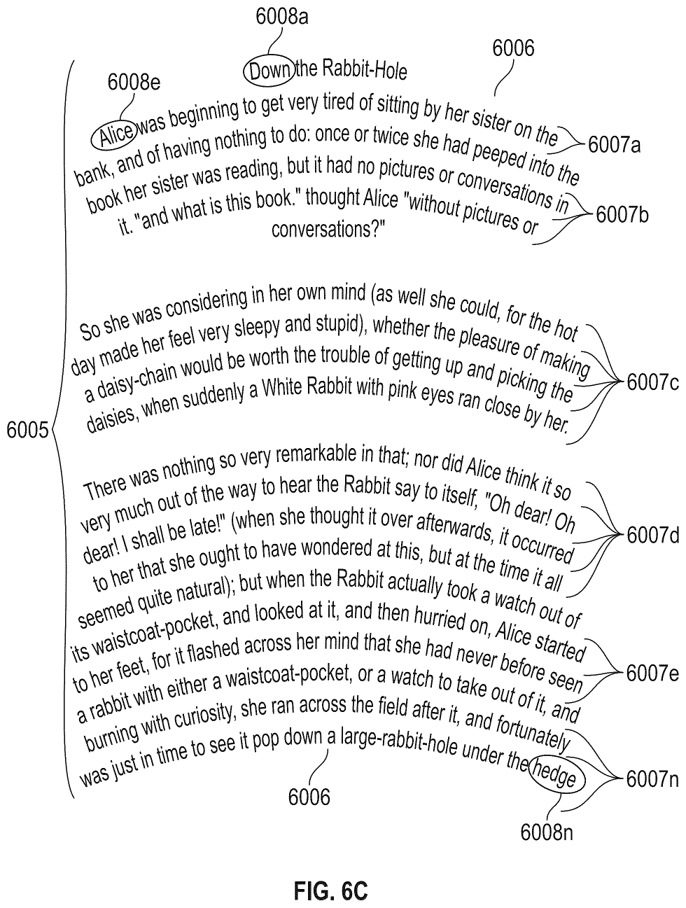

As depicted, the method may include the use of two dimensional, linear text, letter, symbol, word, sentence or phrase (collectively “information”; e.g., see FIG. 6A) that may take the form of, for example, a document 503a (e.g., scanned document), stored electronic data 503a (e.g., a web site stored in a browser that is then displayed, from an electronic device such as a memory “thumb drive” or hard drive, etc.) in a linear image format that is input into, or processed by, a local electronic device 503b.

Alternatively, the linear formatted information may be manually input using a keyboard or touchscreen 503a, for example that is part of, or attached to, the local device 503b. The information may alternatively come from other devices, whether manually typing in, cutting and pasting, selecting or otherwise garnering, using smartphones, generally designated by the reference numeral 531, tablets or like portable devices, generally designated by the reference numeral 531, or other electronic communications and telecommunication devices, as discussed in more detail hereinbelow.

In a first embodiment the local device 503b may access an installed APP or app, plug-in or stored electronic instructions, for example, and if necessary, communicate with a remote server 500 and send the inputted information to the server 500 in electronic form (electronic signals).

Upon receiving the inputted information a processor (or processors) within the server 500 may be operable to execute electronic instructions stored as electronic signals in electronic memory (either onboard internal memory 504a or separate or external memory 504b) for converting the received information from its linear image format to a non-linear image format that includes one or more positioned non-linear boundaries, such as that shown in FIGS. 1A to 1C, 2A to 2C, 3A to 3E. 4A to 4C, 5D to 5G, 5I to 5L, 6B, 6C and 7A to 7I, for example.

Such instructions may further comprise instructions on positioning the textual objects from boundaries 4 at a first, third or fourth distances described herein, positioning the boundaries from one another at a second distance described herein, generating the non-linear boundaries themselves, generating 3-D objects, generating 3-D borders, generating a geometric shape of an image, generating one or more of grammatical letters, words, numbers, or symbols, to name some of the types of instructions.

In sum, the instructions are functionally executed by the operation of the electronic processor to generate a dyslexic-friendly readable image comprising the surface or background portion, one or more positioned non-linear boundaries, and one or more textual objects, where the one or more textual objects may be positioned on the portion such that each object is at a first distance from the one or more positioned non-linear boundaries, for example.

In this embodiment it is assumed that the linear formatted information originates from another medium, such as a physical book, piece of paper or the local electronic device 503b itself where the original information may be received by, copied, transferred, scanned or manually input (collectively “input”) into, the local device 503b using means known in the art before the information is communicated to the server 500.

As noted hereinbelow, the linear-inputted information can also originate from other media, such as the user copying text from a website on the Internet (or perhaps an Intranet).

The local device 503b or the smartphone 531 or the tablet 532 may communicate the information and other necessary signaling via wired or wireless means with the server 500. The server 500 may be a part of the same local or Wi-Fi communications network as the local device 503b or may reside in a different communications network or domain.

In another embodiment images that include, among other features, inventive non-linear boundaries (such as those depicted in FIGS. 1A to 1C, 2A to 2C, 3A to 3E, 4A to 4C, 5D to 5G, 5I to 5L, 6B, 6C and 7A to 7I, for example) may be generated by converting linear formatted text into a dyslexic-friendly, readable image using an electronic device 503b without the aid of a server 500. In such an embodiment the local electronic device 503b may execute stored instructions to electronically read one or more selected portions of the linear formatted text (e.g., from a web site), and electronically convert the selected text into a non-linear, dyslexic-friendly readable image, where the converted image comprises at least a surface or background portion(s), one or more positioned non-linear boundaries, one or more textual objects, where the one or more textual objects are positioned on the portion such that each object is at a first distance (e.g., a same first distance) from the one or more non-linear boundaries.

Alternatively, stored image data (from electronic storage 504a, 504b for example) may be used to generate a non-linear, dyslexic-friendly readable image by the processor within the local device 503b or by the server 500 based on executing instructions stored as electronic signals in electronic memory.

In the latter case, the server 500 may generate the inventive images without the need to receive signals representing linear formatted information or images from the local device 503b or convert such linear information or images, for example. Such instructions may be functionally executed by the server to generate dyslexic-friendly, readable images comprising surface or background portion(s), one or more positioned non-linear boundaries, one or more textual objects, where the one or more textual objects are positioned on the portion such that each object is at a first distance (e.g., a same first distance) from the one or more non-linear boundaries.

As described above, rather than send signals representing linear formatted information to the server 500, the local device 503b may comprise means for creating a dyslexic-friendly readable image.

For example, in a scenario where the original linear formatted information is not already in an electronic form (e.g., it needs to be scanned or manually input using a keyboard, for example) such means may comprise an electronic receiver that is operable to receive linear formatted information, and an electronic processor operable to execute stored instructions (either onboard or separate memory; not shown in FIG. 5A; e.g., an APP, or plug-in for example) to convert the received, linear formatted information into one or more dyslexic-friendly readable images comprising a surface or background portion, one or more positioned non-linear boundaries, one or more textual objects, where the one or more textual objects are positioned on the portion such that each object is at a first distance (e.g., a same first distance) from the one or more positioned non-linear boundaries. In such an embodiment the device 503b may further comprise an electronic storage device operable to store the received, linear formatted information and/or the images.

As noted, each of the so converted non-linear images may include one or more positioned non-linear boundaries such as that shown in FIGS. 1A to 1C, 2A to 2C, 3A to 3E, 4A to 4C, 5D to 5G, 5I to 5L, 6B, 6C and 7A to 7I for example.

Alternatively, an exemplary means for creating a dyslexic-friendly readable image may comprise, for example, an electronic storage device (e.g., electronic memory) operable to store image data, and an electronic processor operable to generate dyslexic-friendly readable images from the stored image data based on executing stored instructions (e.g., an APP, or plug-in for example). It should also be understood that the electronic storage devices may be smartphones, tablets and other portable devices each having memory therein and communications means for data interchange.

In each of the embodiments described herein such instructions may comprise instructions on positioning the textual objects from boundaries at a first, third or fourth distances described herein, positioning the boundaries from one another at a second distance described herein, generating the non-linear boundaries themselves, generating 3-D objects, generating 3-D borders, generating a geometric shape of an image, generating one or more of grammatical letters, words, numbers, or symbols, to name some of the types of instructions.

In each of the embodiments described herein the mathematical slope (“slope”) of a non-linear boundary may be varied. For example, when inventive non-linear images are displayed by an electronic device a so-displayed image may include a non-linear boundary having a slope between points along the boundary that is greater than one, (e.g., steep slope) or less than one, provided of course the slope between each point cannot be zero. That said, there may be one point in the substantially center of a non-linear boundary (e.g., at the bend of a curved line) that corresponds to a plane whose slope may be zero.

In embodiments of the invention, a user of an electronic device may be presented with indicators or tools that allow a user to vary the slope of the non-linear boundaries, for example, on a touch or other screen using your finger to modify the aforesaid slope up and down, which is described in more detail hereinbelow. In such an embodiment a processor may execute instructions stored in memory to adjust the slope of a non-linear boundary or boundaries of an inventive image.

Yet further the means for creating a dyslexic-friendly, readable image may comprise a physical device or medium (a device that is primarily mechanical or electro-mechanical, as opposed to electronic) comprised of one or more components as described elsewhere herein.

Continuing, once an inventive non-linear image has been generated based on stored image data or by an inventive conversion process an inventive processor in either the local device 503b or server 500 may be further operable to execute additional, stored instructions to forward or send the so generated image to a printer 501, local printer 503b, separate electronic display 502 or to a display that is part of the local device 503b so that the converted image may be thereafter reproduced for viewing by a person with a learning difference, such as a dyslexic.

As shown in FIG. 5A, the components may also communicate, either through wireline or wireless signals, to a cloud service, generally designated by the reference numeral 530, which could, for example, communicate wirelessly with all of the components depicted

It should be understood that the electronic display 502 may be part of a larger device or system such as an electronic whiteboard, laptop, desktop, smartphone, personal digital assistant, mobile communication terminal, media player, navigational device, electronic book, electronic notepad and other electronic devices offering access to information. Similarly, the local device 503b may also comprise an electronic display, electronic whiteboard, laptop, desktop, smartphone, personal digital assistant, mobile communication terminal, media player, navigational device, electronic book, electronic notepad and other electronic devices offering access to information. Other devices may be employed to facilitate use, e.g., a mouse or other such tactile device, generally designated by the reference numeral 533.

Referring now to FIG. 5B of the DRAWINGS, there is depicted the display of two-dimensional, linear formatted text, generally designated by the reference numeral 505, from an article in an online publication, generally designated by the reference numeral 506, such as may be found on the Internet, on an electronic device, such as the display for device 503b, for example, or one of the other electronic devices mentioned elsewhere herein.

As depicted in FIG. 5C of the DRAWINGS, in an embodiment, linear formatted text, generally designated by the reference numeral 505a, that is to be converted into an inventive non-linear, formatted image may be first selected using one or more methods, such as electronically highlighting the text to be converted on the display of the electronic device. While all of the text 505 in FIG. 5B has been selected for conversion as shown in FIG. 5C, it should be understood that this is merely exemplary.

Alternatively, only a portion of the text 505 may be selected for conversion into an inventive non-linear, formatted image. In an embodiment, a processor or processors within the electronic device that is displaying the selected text 505a may be operable to execute instructions stored in one or more memories for reading the selected text 505a and then converting the selected text 505a into an inventive, non-linear formatted image or images.

In an embodiment, the stored instructions may take the form of a so-called software “plug-in”. In addition, the instructions may be a part of an APP and/or some instructions may be executed by a server, such as server 500 that is communicating with the electronic device.

Referring now to FIG. 5D of the DRAWINGS, there is depicted an exemplary, non-linear formatted image 507 comprising at least one or more positioned non-linear boundaries 508a to 508n (where “n” again denotes the last boundary), one or more objects 510a to 510n (where “n” again denotes the last object) and a background portion 511 that have been converted from the selected text 505a using stored instructions.

Optionally, one or more separate indicators 509 (e.g., icons, symbols) which indicate that a conversion has occurred may be displayed or otherwise indicated to a user of the electronic device that is displaying the image 507, generally illustrated in FIGS. 5D-5I.

Further, stored instructions may also comprise instructions on positioning the textual objects 510a to 510n, from boundaries 508a to 508n at a first, third or fourth distances described herein, positioning the boundaries 508a to 508n from one another at a second distance described herein, generating the non-linear boundaries themselves 508a to 508n, generating 3-D objects, generating 3-D borders, generating a geometric shape of an image 507, generating one or more of grammatical letters, words, numbers, or symbols, to name some of the types of instructions.

In sum, the instructions are functionally executed by the operation of the electronic processor to generate the dyslexic-friendly, readable image 507 comprising the surface or background portion 511, the one or more positioned non-linear boundaries 508a to 508n, the one or more textual objects 510a to 510n, where the one or more textual objects 510a to 510n are positioned on the portion 511 such that each object 510a to 510n is at a first distance (e.g., a same first distance) from the one or more positioned non-linear boundaries 508a to 508n, for example.

With reference now to FIGS. 5E to 5G of the DRAWINGS, there are depicted additional features of an inventive method according to an embodiment of the invention. As shown one or more objects 510a to 510n, such as exemplary object 510x, may be electronically selected within the document or image 507 for further processing by a processor within the electronic device operable to execute instructions stored in one or more memories. In the example illustrated in FIGS. 5E to 5G, after the object 510x is selected, the processor executes instructions to display or otherwise present to a user a list 512 of functional or informative indicators 513a to 513n correlating to the selected object 510x. As shown, the list 512 may take the form of a drop-down menu, for example, which may overlay the text.

Thereafter, the user may electronically select an indicator 513a to 513n from the list 512. Upon selection of an indicator 513a to 513n, the processor may execute stored instructions to complete the function or display the information associated with selected indicator 513 a to 513n.

In the embodiments depicted in FIGS. 5E to 5G, the function associated with the indicator 513a may comprise a “definition” function. Thus, in an embodiment, a definition 514 for the word “employees” 510x (or one of its tenses, e.g., “employee” 5100x) that comprises the object 510x may be searched for, located, displayed or otherwise presented (collectively “presented”) to the user (see FIG. 5G).

It should be understood that definitions may be stored in memory within an electronic device or, perhaps more typically, may be stored by one or more online servers associated with a web site that the device (e.g., its processor) communicates with to electronically locate and retrieve for display to a user.

Referring again to FIG. 5E, as illustrated, one or more objects 510a to 510n may be selected, in this case highlighted. In an alternative embodiment one or more (e.g., a plurality) of objects 510a to 510n along a non-linear boundary 508a to 508n may be selected and boldened for emphasis (collectively “emphasized”) while, at the same time, objects 510a to 510n that are not selected (“non-selected object”) are not emphasized. For example, a user may select one set of objects 510a to 510n associated with one boundary 508a to 508n for emphasis while de-emphasizing the non-selected objects 510a-510n by, for example, boldening the emphasized set for display, and/or faintly displaying the de-emphasized objects. This emphasis/de-emphasis may be repeated for objects 510a-510n along a plurality of adjacent or non-adjacent boundaries 508a-508n.

It should be understood that the selection of text to be emphasized/de-emphasized may occur prior to conversion of the linear formatted text 505 into a non-linear, dyslexic-friendly image. In such a scenario the text to be emphasized and/or de-emphasized is selected and upon conversion the selected text is either displayed or otherwise presented to the user (e.g., printed out) as an emphasized or de-emphasized portion of a non-linear, dyslexic-friendly image. Further, a user may choose to select and emphasize only a portion of objects that make up a set that are associated with the same boundary (e.g., some words along the same boundary are emphasized, while some are not).

With reference now to FIGS. 5H and 5I of the DRAWINGS, during use of the tools of the instant invention, the user may adjust various parameters or indicators 509, where the options vary, generally designated by the reference indicators 515a to 515n. These parameters illustratively include font size, letter spacing, and arc height. It should, of course, be understood that various other indicators 509 could be listed. As a result of modifications made, the image portrayed in FIG. 1 has been adjusted from the default, for example. The indicator flag 509 is set to show the adjustment.

Referring now to FIGS. 5J to 5L there is depicted still more features of an inventive method according to another embodiment of the invention. As shown in FIG. 5J, an exemplary, non-linear formatted image, generally designated by the reference numeral 517, comprising at least one or more positioned non-linear boundaries 521a to 521n (where “n” again denotes the last boundary), one or more textual objects 520a to 520n (where “n” again denotes the last object) and a background portion (not labeled for the sake of clarity) that have been converted from the selected text 516 using stored instructions by a processor within the electronic device operable to execute instructions stored in one or more memories. Also shown is an “edit indicator,” generally designated by the reference numeral 518, that may be generated and so displayed by executing stored electronic instructions as well.

Referring now to FIG. 5K, in an embodiment a user may select (e.g., highlight) an object 520x to be edited (e.g., correct the spelling of the object, insert an object by typing the object in, delete the object, copy an object, or paste in another object if a “spatial” object (a space) is selected, etc.) using a cursor 522, such as shown in FIG. 5L.

Thereafter, the user may edit the object 520x by, for example, selecting the edit indicator 518 (e.g., move a cursor over, and click on, the indicator; an exemplary cursor and typing 522 is shown in FIG. 5L) in order to initiate a process whereby the electronic processor completes the function of editing. To visually indicate to the user that objects within the image 517 are being edited, a border 519 or other image editing indicator may be displayed to the user. The indicator 519 may surround all, or part, of the inventive image, for example.

Once an object in an inventive, non-linear, dyslexic-friendly image has been edited, the inventive, edited image may then be displayed, or sent to a printer, for example.

Alternatively, the inventive, edited image may be re-converted back it to its original, linear format text or image.

In each of the embodiments depicted in FIGS. 5J to 5L (as well as the other figures that depict an inventive, non-linear dyslexic-friendly image) the objects may be configured such that the objects are aligned along, adjacent or associated with a non-linear boundary such that a first and last object in a group of objects (e.g., the first and last words in a sentence) aligned along, adjacent or associated with the same boundary are spaced a distance from a margin or border (the latter in the case where the editing feature has been selected and displayed).

In an embodiment a group of objects (e.g., sentence) may be displayed such that one group of objects appears to “wrap” around to another group of objects (e.g., to the next sentence).

In another embodiment, rather than generate the image using an electronic device, such as local device 503b or through server 500, the image may be generated by constructing components of a physical device or medium (a device that is primarily mechanical or electro-mechanical, as opposed to electronic), where each component represents an element of a dyslexic-friendly readable, non-linear image.

For example, referring back to FIGS. 1A to 1C, the components of such a physical device or medium may comprise a background portion 3, positioned non-linear boundaries (i.e., curved) lines 4a to 4n (where “n” represents the last boundary) that divides the eventual image into locations, and one or more textual objects 2a to 2n representing the text. It should be understood that one or more of the components need not be flat. For example, each of the boundaries 4a to 4n and/or textual objects 2a to 2n may be represented as, or correspond to, a raised 3D component (e.g., for a textual object, a physical rectangular block of wood, for example) with a letter or other symbol, for example, applied to it giving the corresponding component a 3D appearance.

The composition of each of the components and the device or medium itself may comprise a type of wood, metal, vinyl or plastic, or some combination of such materials, for example. Alternatively, one or more of the elements of the image 1 may be represented by a paint or similar material applied to the surface of the device or medium (e.g., for the non-linear boundaries). Regardless of the device or medium's or component's composition, in an embodiment the components corresponding to textual objects may be positioned as described previously - - - at a first, third or fourth distance from components corresponding to boundaries above and/or below the objects and following a positioned boundary above and/or below the object.

The resulting physical device or medium may effectively, visually separate components corresponding to a word or phrase and/or elements thereof (e.g., letters) in text from another component corresponding to a word or phrase using the boundaries so that a person with a learning difference, such as a dyslexic, can read and understand the text that is represented by the components.

The component corresponding to the background portion 3 or another supporting portion of the physical device or medium may have a circumference, perimeter or edge shaped as a circle or oval to correspond to the shape of the entire image 1.

When the image 1 is created using such a physical device or medium it may be necessary to apply one or more elements or parts of the image 1 to individual components of the physical device or medium. For example, each of the textual objects (e.g., letters) may be individually applied/labeled to a physical component of the physical device (e.g., a letter is applied to a 3D block of wood).

Thereafter, the so labeled component with its corresponding textual object may be inserted onto the surface of the physical device and positioned along a component corresponding to one of the positioned non-linear (i.e., curved) boundaries (similar to boundaries 4a to 4n) that have also been formed and positioned on the surface of the physical device or as a raised component so that each component corresponding to an object is at a first, third or fourth distance from components corresponding to boundaries above and/or below the objects and following a positioned boundary above and/or below the object as noted previously.

The positioning of the components corresponding to textual objects from a boundary or boundaries and the positioning of the boundaries themselves effectively, visually separates a word or phrase and/or elements so represented (e.g., letters) from another word or phrase so that a person with a learning difference, such as a dyslexic, can read and understand the represented components.

As shown image 1 includes textual objects 2a to 2n representing the word “Washington” as an example. The word “Washington” may be separated and then presented in a non-linear format so that the image 1 can be readily read and understood by a person with a learning difference, such as a dyslexic.

While a single word is represented by the objects 2a to 2n in FIGS. 1A to 1C, it should be understood that this is merely exemplary and more than one word may be represented by one or more of the objects 2a to 2n. Conversely, a word with fewer letters (e.g., as few as one letter) or letters that do not comprise a word (e.g., the alphabet) may represented by one or more of the objects 2a to 2n. The inventor believes that presenting a word or words using the non-linear boundaries depicted in FIGS. 1A to 1C substantially improves the ability of a person with a learning difference, such as a dyslexic, to read and comprehend sentences represented by the image 1.

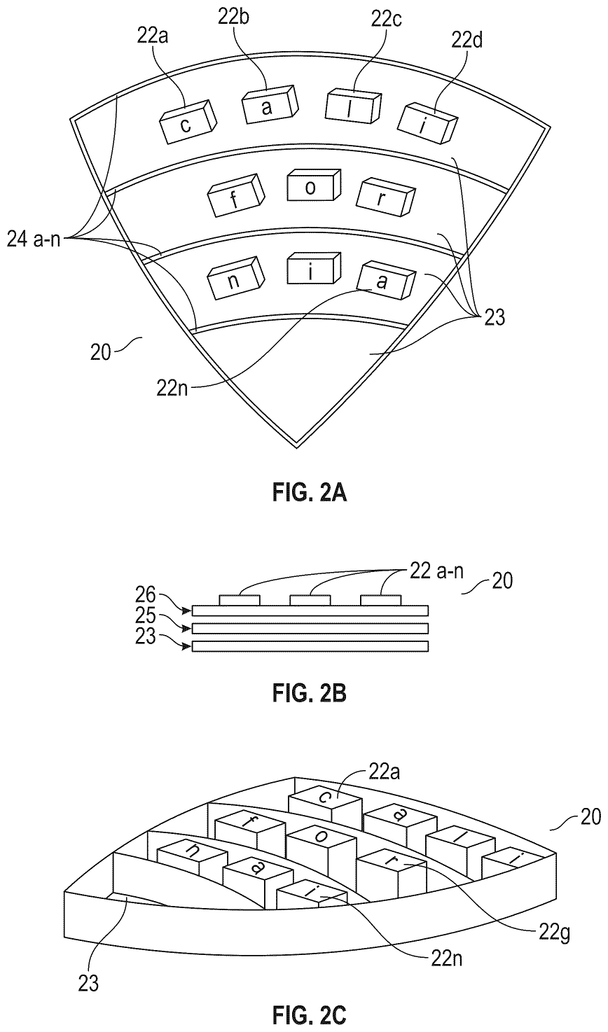

Referring now to FIGS. 2A to 2C f the DRAWINGS, there is depicted another exemplary inventive dyslexic-friendly readable image 20 generated in accordance with an embodiment of the invention. As shown the image 20 may comprise a surface or background portion 23 with positioned non-linear (i.e., curved) boundaries 24a to 24n (where “n” represents the last boundary) for dividing the image into locations and one or more textual objects 22a to 22n representing text positioned on the portion such that each object is at a first distance (e.g., a reasonable first distance) from the one or more positioned non-linear boundaries 24a to 24n.

As noted previously, the one or more objects 22a to 22n may comprise one or more grammatical letters, words, numbers, and symbols, for example (i.e., “text”). Still further, in one embodiment, each of the objects 22a to 22n may comprise text presented in a block-lettering format.

In one embodiment the first distance may comprises an equal distance from the one or more positioned non-linear boundaries 24a to 24n, that are located above and below the one or more objects 22a to 22n, to the objects 22a to 22n. Alternatively, first distance may be an equal distance from the positioned non-linear boundaries 24a to 24n that is located above or below the one or more objects 22a to 22n, to the objects 22a to 22n.

Accordingly, the objects 22a to 22n may appear to “follow” the positioned non-linear boundaries 24a to 24n. Because of the positioning of the textual objects, and the positioning of the boundaries the image 20 effectively, visually separates text (e.g., a word or phrase and/or elements thereof (e.g., letters) from another word or phrase) so that a person with a learning difference, such as a dyslexic, can read and understand the text represented by the image 20.

As depicted in FIGS. 2A and 2C, the entire image 20 may be formed as a shield-like image. As depicted in FIGS. 2A and 2C the entire image 20 may be formed as an inverted Reuleaux triangle or shield-shaped image. Accordingly, when the entire image is reproduced it may be reproduced as an inverted Reuleaux triangle or shield-shaped image. Still further, the image 20 may optionally comprise a 3D border 26. The border may appear on top of edge of the image 20. Yet further the image may include an optional colored film 25 between the triangle/shield and the border structure, if desired, for additional contrast.

Though the objects 22a to 22n may be a first distance from each of the one or more positioned boundaries 24a to 24n, the boundaries 24a to 24n themselves may each be separated or positioned from one another by a second distance.

In one embodiment, the first distance may be substantially or about ⅓ of the second distance.

In yet another embodiment, one or more of the one or more positioned boundaries 24a to 24n may be located above or below each of the one or more objects 22a to 22n at a third distance from each of the one or more objects 22a to 22n, while another one of the one or more positioned boundaries may be located below or above the one or more objects and is at a fourth distance, where the third and fourth distances may be different from each other and may vary from a second distance by up to about 10%.

Alternatively, the third and fourth distances may be the same distance. Though the exemplary images shown in the figures depict continuous positioned boundaries it should be understood that the boundaries may comprise one or more undulations.

The image 20 may be initially generated using similar methods described herein using, for example, the processor in server 500, the various means for creating a dyslexic-friendly, readable image in local device 503b described herein (including using the types of electronically stored instructions described herein) or by creating a physical device or medium with the understanding that the means for creating a dyslexic-friendly image may comprise one or more processors operable to execute instructions stored as electronic signals in electronic memory (either onboard or separate memory) for converting text from a linear image format to an non-linear, dyslexic-friendly readable image 20 that includes one or more positioned non-linear boundaries.

It should be understood that the aforesaid one or more positioned non-linear boundaries can formed as an inverted Reuleaux triangle or shield shape 20, or alternatively, generating the image 20 formed as an inverted Reuleaux triangle or shield shape based on images (image data) stored in memory 504a, 504b, for example.

Further, once the inventive image 20 has been generated a processor in either the local device 503b or server 500 may be further operable to execute additional, stored instructions to control the forwarding or sending of the so generated image to a printer 501, local printer 503b, separate display 502 or to a display that is part of the local device 503b so that the converted image may be thereafter reproduced for viewing by a person with a learning difference, such as a dyslexic.

As with the images in FIGS. 1A to 1C, the image 20 may be generated by constructing components of a physical device or medium (a device that is primarily mechanical or electro-mechanical, as opposed to electronic), where each component represents an element of the image.

For example, the components of such a physical device or medium may comprise components corresponding to background portion 23, positioned non-linear (i.e., curved) boundaries 24a to 24n (where “n” represents the last boundary) that divides the eventual image into locations, and one or more textual objects 22a to 22n representing text. It should be understood that one or more of the components need not be flat.

For example, each of the positioned boundaries 24a to 24n or textual objects 22a to 22n may comprise a raised 3D component (e.g., for a textual object, a physical rectangular block of wood, for example) with a letter or other symbol, for example, applied to it giving the component a 3D appearance.

The composition of each of the components and the device or medium itself may again comprise a type of wood, metal, vinyl or plastic, or some combination of such materials, for example.

Alternatively, one or more of the elements of the image 20 may be a paint or similar material applied to the surface of the device or medium (e.g., for the non-linear boundaries).

Regardless of the device or medium's or component's composition, in an embodiment the components corresponding to textual objects 22a to 22n may be positioned as described previously - - - at a first, third or fourth distance from components corresponding to positioned boundaries above and/or below the objects and following a boundary above and/or below the object.

The resulting physical device or medium may effectively, visually separate components corresponding to a word or phrase and/or elements thereof (e.g., letters) in text from another component corresponding to a word or phrase using the positioned boundaries so that a person with a learning difference, such as a dyslexic, can read and understand the text that is represented by the components.

The component corresponding to the background section 23 or another supporting section of the physical device or medium may have a perimeter or edge shaped as an inverted Reuleaux triangle or shield to correspond to the shape of the image 20. When the image 20 is created using such a physical device or medium it may be necessary to apply one or more elements or parts of the image 20 to individual components of the physical device. For example, each of the textual objects (e.g., letters) 22a to 22n may be individually applied/labeled to a physical component of the physical device or medium (e.g., a letter is applied to a 3D block of wood).

Thereafter, the so labeled component with its corresponding textual object may be inserted onto the surface of the physical device and positioned along one of the positioned non-linear (i.e., curved) boundaries (similar to lines 24a to 24n) that have also been positioned or formed on the surface of the physical device or as a raised component so that each component corresponding to an object is at a first, third or fourth distance from components corresponding to positioned boundaries above and/or below the objects and following a boundary above and/or below the object as noted previously.

The positioning of the components corresponding to textual objects 22a to 22n from, and/or along, a boundary or boundaries and the positioning of the boundaries themselves effectively, visually separates a word or phrase and/or elements so represented (e.g., letters) in text from another word or phrase so that a person with a learning difference, such as a dyslexic, can read and understand the text based on the components.

Referring again to FIGS. 2A to 2C, as shown image 20 includes textual objects 24a-24n representing the word “California” as an example. As shown, the word “California” is separated and presented in a non-linear format that can be readily read and understood by a person with a learning difference, such as a dyslexic. While a single word is represented by the objects 24a to 24n, it should be understood that this is merely exemplary, and more than one word may be represented by the objects 24a to 24n. Conversely, a word with fewer letters (e.g., as few as one letter) or letters that do not comprise a word (e.g., the alphabet) may be represented by the objects 24a to 24n. The inventor believes that presenting a word or words from, and/or along a positioned boundary or boundaries depicted in FIGS. 2A to 2C substantially improves the ability of a person with a learning difference, such as a dyslexic, to read and comprehend individual words.

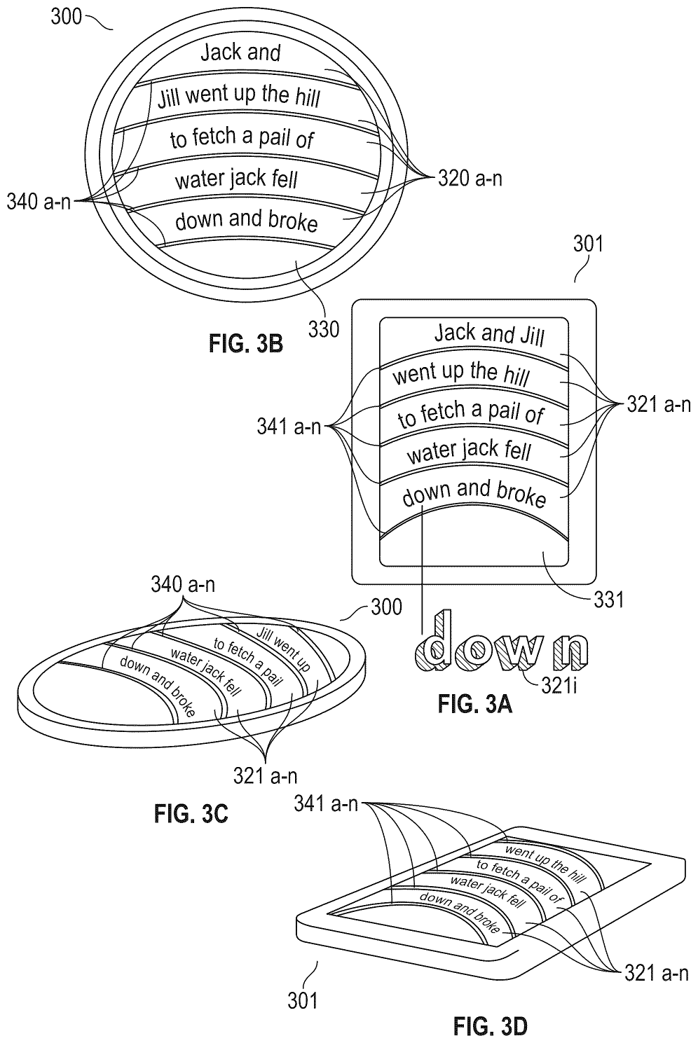

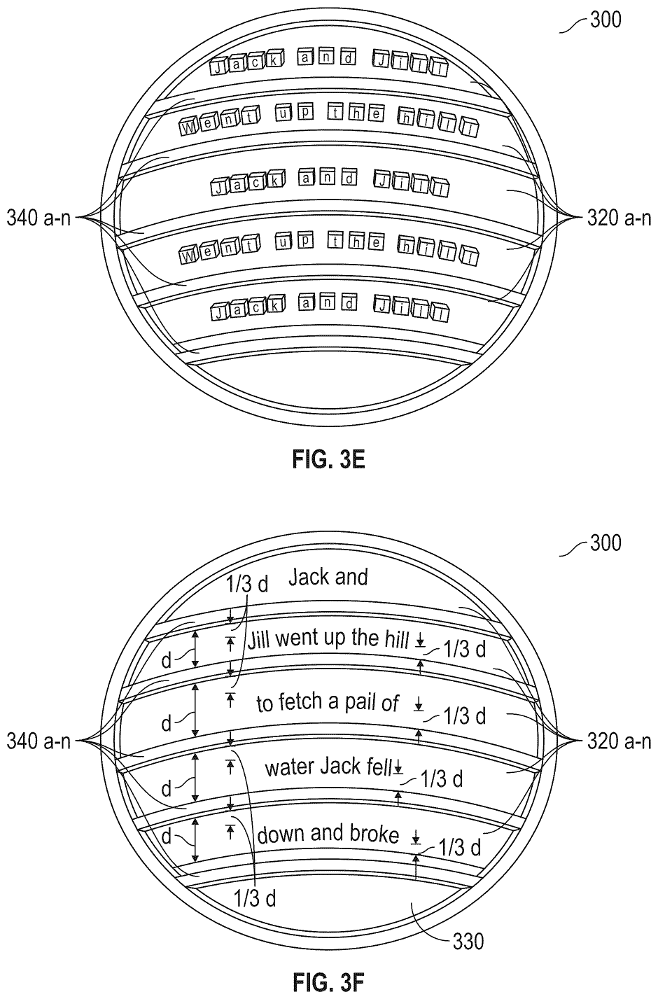

Referring now to FIGS. 3A to 3F of the DRAWINGS, there are depicted additional exemplary inventive images 300, 301 generated in accordance with an embodiment of the invention.

As shown images 300, 301 may comprise a surface or background portion 330, 331 respectively with positioned non-linear (i.e., curved) boundaries 340a-340n, 341a-341n, respectively, for dividing the image into locations and one or more textual objects 320a to 320n, 321a to 321n (e.g., see FIG. 3E), respectively, positioned on the portion such that each object is at a same first distance from the one or more positioned non-linear boundaries 340a to 340n, 341a to 341n.

As noted previously, the one or more objects 320a to 320n, 321a to 321n may comprise one or more grammatical letters, words, numbers, and symbols, for example (i.e., “text”). Still further, in one embodiment, each of the objects 320a-320n, 321a-321n may comprise text presented in a block-lettering format.

In one embodiment the first distance may comprise an equal distance from the one or more positioned non-linear boundaries 340a-340n, 341a-341n, that are located above and below the one or more objects 320a-320n, 321a-321n, to the objects 320a-320n, 321a-321n.

Alternatively, first distance may be an equal distance from the positioned non-linear boundaries 340a-340n, 341a-341n, that is located above or below the one or more objects 320a-320n, 321a-321n, to the objects 320a-320n, 321a-321n.

Accordingly, the objects 320a-320n, 321a-321n may appear to “follow” the positioned non-linear boundaries 340a-340n, 341a-341n. Because of the positioning of the textual objects and the boundaries the images 300, 301 effectively, visually separates text (e.g., a word or phrase and/or elements thereof (e.g., letters) from another word or phrase) so that a person with a learning difference, such as a dyslexic, can read and understand the text represented by the images 300, 301.

Though the objects 320a-320n, 321a-321n may be a first distance from each of the one or more positioned boundaries 340a-340n, 341a-341n, the boundaries 340a-340n, 341a-341n themselves may each be separated or positioned from one another by a second distance.

In one embodiment, the first distance may be substantially ⅓ of the second distance.

In yet another embodiment, one or more of the one or more positioned boundaries 340a-340n, 341a-341n may be located or positioned above or below each of the one or more objects 320a-320n, 321a-321n at a third distance from each of the one or more objects 320a-320n, 321a-321n, while another one of the one or more boundaries may be located or positioned below or above the one or more objects and is at a fourth distance, where the third and fourth distances may be different from each other and may vary from a second distance by up to about 10%.

Alternatively, the third and fourth distances may be the same distance. Though the exemplary images shown in the figures depict continuous positioned boundaries it should be understood that the boundaries may comprise one or more undulations.

As depicted in FIGS. 3A to 3E an entire image 300, 301 may be formed as a circle/oval 300 or rectangle 301. Accordingly, when the entire image 300, 301 is reproduced it may be reproduced as a circle/oval or as a rectangular.

The images 300, 301 may be generated using similar methods using the processor in server 500, the various means for creating a dyslexic-friendly readable image in local device 503b described herein (including using the types of electronically stored instructions described herein), or by creating a physical device or medium with the understanding that the means for creating a dyslexic-friendly image may comprise one or more processors operable to execute instructions stored as electronic signals in electronic memory (either onboard or separate memory) for converting text from a linear image format to an non-linear, dyslexic-friendly readable image 300, 301 that includes one or more positioned non-linear boundaries formed as circular, oval or rectangular shapes, or alternatively, generating the images 300, 301 formed as circular, oval or rectangular shapes based on images (image data) stored in memory 504a, 504b, for example.

Further, once the inventive images 300, 301 have been generated a processor in either the local device 503b or server 500 may be further operable to execute additional, stored instructions to control the forwarding or sending of the so generated image to a printer 501, local printer 503b, separate display 502 or to a display that is part of the local device 503b so that the converted image may be thereafter reproduced for viewing by a person with a learning difference, such as a dyslexic.

As with the images in FIGS. 1A to 1C and 2A to 2C, the images 300, 301 may be generated by constructing components of a physical device or medium (a device that is primarily mechanical or electro-mechanical, as opposed to electronic), where each component represents an element of the image 300 or 301.

For example, the components of such a physical device or medium may comprise components corresponding to a background portion 330 or 331, positioned non-linear (i.e., curved) boundaries 340a to 340n or 341a to 341n that divides the eventual image into locations, and one or more textual objects 320a to 320n or 321a to 321n representing the text.

It should be understood that one or more of the components need not be flat. For example, each of the boundaries 340a to 340n or 341a to 341n or textual objects 320a to 320n or 321a to 321n may comprise a raised 3D component (e.g., for a textual object, a physical rectangular block of wood, for example) with a letter or other symbol, for example, applied to it giving the component a 3D appearance.

The composition of each of the components and the device or medium itself may again be a type of wood, metal, vinyl or plastic, or some combination of such materials, for example.

Alternatively, one or more of the elements or parts of an image may be a paint or similar material applied to the surface of the device or medium (e.g., for the non-linear lines).

Regardless of the device's or medium's or component's composition, in an embodiment the components corresponding to textual objects 320a to 320n or 321a to 321n n may be positioned as described previously - - - at a first, third or fourth distance from components corresponding to positioned boundaries above and/or below the objects and following a positioned boundary above and/or below the object.

The one or more positioned, non-linear curved boundaries of images 300 or 301 represented by the components of the physical device or medium may effectively, visually separate a word or phrase and/or elements thereof (e.g., letters) in text from another word or phrase so that a person with a learning difference, such as a dyslexic, can read and understand the text represented by components of image 300 or 301.

The component corresponding to the background section 330 or 331 or another supporting section of the physical device or medium may have a perimeter or edge shaped as a circle/oval or rectangle to correspond to the shape of the image 300 or 301.

When an image 300 or 301 is created using such a physical device or medium it may be necessary to apply one or more elements or parts of an image 300 or 301 to individual components of the physical device or medium. For example, each of the textual objects (e.g., letters, words, sentences) 320a to 320n or 321a to 321n may be individually applied/labeled to a physical component of the physical medium or device (e.g., a letter or word is applied to a 3D block of wood; see FIG. 3E).

Thereafter, the so labeled component with its corresponding textual object may be inserted onto the surface of the physical device or medium and positioned along one of the positioned non-linear (i.e., curved) boundaries (similar to boundaries 340a to 340n or 341a to 341n) that have also been formed or positioned on the surface of the physical device or medium (e.g., painted on) or as a raised component so that each component corresponding to an object is at a first, third or fourth distance from components corresponding to boundaries above and/or below the objects and following a boundary above and/or below the object as noted previously.

The positioning of the components corresponding to textual objects 320a to 320n or 321a to 321n from, and/or along a boundary or boundaries and the positioning of the boundaries themselves effectively, visually separates a word or phrase and/or elements so represented (e.g., letters) in text from another word or phrase so that a person with a learning difference, such as a dyslexic, can read and understand the text represented by the components.

Referring now to FIG. 3F of the DRAWINGS, there is depicted an enlarged view of exemplary objects 320a to 320n and exemplary positioned boundaries 340a to 340n. In an embodiment, a preferred positioning of objects 320a to 320n is such that each of the objects is a first distance that is equidistant from a positioned boundary 340a to 340n, where the first distance is ⅓d, where “d’ is the second distance between boundaries 340a to 340n, from each curved boundary positioned above and below the object and follows a curved boundary 340a-340n positioned below the object. In this embodiment the second distance is the total distance between two boundaries.

It should be understood that this positioning may be applied to each of the inventive images described herein and covered by the inventive ideas.

Further, separately, in an embodiment, a preferred positioning of objects 320a to 320n is such that each of the objects 320a to 320n is a first distance ½d, where “d’ is the second distance between positioned boundaries 340a to 340n, from another object 320a to 320n and follows a curved boundary 340a to 340n positioned below the object. Again, in this embodiment the second distance is the total distance between two boundaries 340a to 340n.

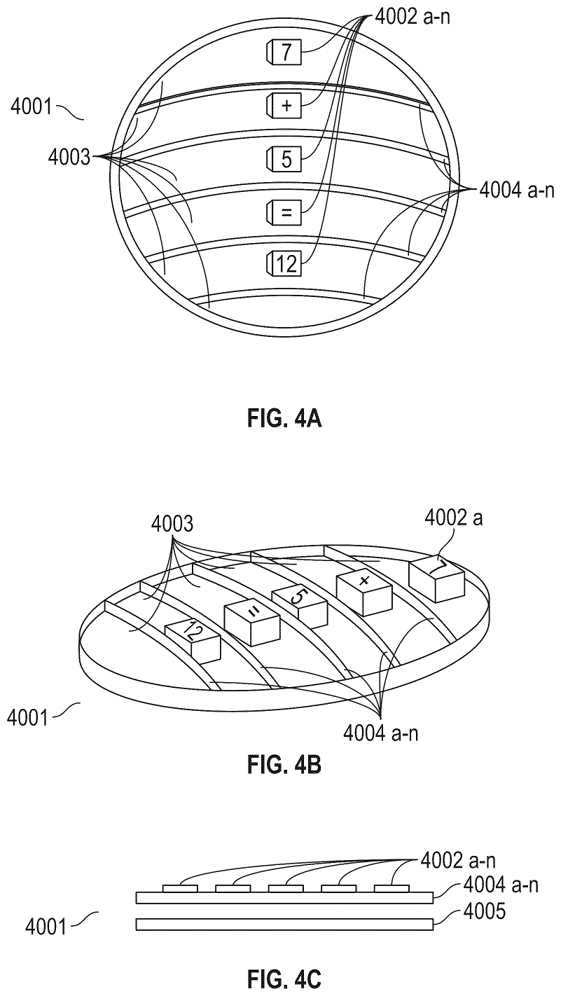

Referring now to FIGS. 4A to 4C of the DRAWINGS, there is depicted another exemplary inventive image 4001 generated in accordance with an embodiment of the invention.

As shown image 4001 may comprise a surface or background portion 4003, respectively, with positioned non-linear (i.e., curved) boundaries 4004a to 4004n for dividing the image into locations and one or more textual objects 4002a to 4002n (e.g., 3-D objects) representing text, where the text is positioned on the portion such that each object is at a same first distance from the one or more positioned non-linear boundaries 4004a to 4004n.

In this embodiment the text comprises mathematical numbers, symbols or operators, for example. By so positioning the textual objects from, and/or along a positioned boundary or boundaries, the image 4001 effectively, visually separates a mathematical number, symbol or operator from another a mathematical number, symbol or operator so that a person with a learning difference, such as a dyslexic, can read and understand the mathematical number, symbol or operator, for example, represented by the image 4001.

Still further, the image 4001 may optionally comprise a 3D border 4004a to 4004n that corresponds to the circle/oval shape of the image 4001. The border may appear on top of edge of the image 4001.

In one embodiment the first distance may comprise an equal distance from the one or more positioned non-linear boundaries 4004a to 4004n, that are located above and below the one or more objects 4002a to 4002n, to the objects 4002a to 4002n.

Alternatively, the first distance may be an equal distance from the positioned non-linear boundaries 4004a-4004n, which is located above or below the one or more objects 4002a-4002n, to the objects 4002a-4002n. Accordingly, the objects 4002a-4002n may appear to “follow” the positioned non-linear boundaries 4004a-4004n. Because of the positioning of the textual objects and the boundaries, the image 4001 effectively, visually separates text (e.g., a number, symbol and/or elements thereof) from other text so that a person with a learning difference, such as a dyslexic, can read and understand the text represented by the image 4001.

Though the objects 4002a-4002n may be a first distance from each of the one or more positioned boundaries 4004a-4004n, the boundaries 4004a-4004n themselves may each be separated or positioned from one another by a second distance.

In one embodiment, the first distance may be substantially ⅓ of the second distance.

In yet another embodiment, one or more of the one or more positioned boundaries 4004a-4004n may be located above or below each of the one or more objects 4002a-4002n at a third distance from each of the one or more objects 4002a-4002n, while another one of the one or more positioned boundaries is located below or above the one or more objects and is at a fourth distance, where the third and fourth distances may be different from each other and may vary from a second distance by up to about 10%.

Alternatively, the third and fourth distances may be the same distance. Though the exemplary images shown in the figures depict continuous positioned boundaries it should be understood that the boundaries may comprise one or more undulations.

The image 4001 may be generated using the processor in server 500, the various means for creating a dyslexic-friendly readable image in local device 503b described herein (including using the types of electronically stored instructions described herein), or by creating a physical device or medium with the understanding that the means for creating a dyslexic-friendly image may comprise one or more processors operable to execute instructions stored as electronic signals in electronic memory (either onboard or separate memory) for converting text from a linear image format to an non-linear, dyslexic-friendly readable image 4001 that includes one or more positioned non-linear boundaries formed as a circular shape, or alternatively, generating the image 4001 formed as a circular shape based on images (image data) stored in memory 504a, 504b, for example.

Further, once the inventive image 4001 has been generated a processor in either the local device 503b or server 500 may be further operable to execute additional, stored instructions to control the forwarding or sending of the so generated image to a printer 501, local printer 503b, separate display 502 or to a display that is part of the local device 503b so that the converted image may be thereafter reproduced for viewing by a person with a learning difference, such as a dyslexic.

As with the images in FIGS. 1A to 1C, 2A to 2C and 3A to 3E, the image 4001 may be generated by constructing components of a physical device or medium (a device that is primarily mechanical or electro-mechanical, as opposed to electronic), where each component represents an element or part of the image 4001. For example, the components of such a physical device or medium may comprise components corresponding to a background portion 4003, positioned non-linear (i.e., curved) boundaries 4004a to 4004n (where “n” represents the last boundary) that divides the eventual image into locations, and one or more textual objects 4002a-4002n representing the text.

It should be understood that one or more of the components need not be flat. For example, each of the components representing positioned boundaries 4004a to 4004n or textual objects 4002a to 4002n may comprise a raised 3D component (e.g., for a textual object, a physical rectangular block of wood, for example) with a number, symbol, or operator for example, applied to it giving the component a 3D appearance.

The composition of each of the components and the device or medium itself may again be a type of wood, metal, vinyl or plastic, or some combination of such materials, for example. Alternatively, one or more of the elements or parts of the image 4001 may be a paint or similar material applied to the surface of the device or medium (e.g., for the positioned non-linear boundaries). Regardless of the device's or medium's or component's composition, in an embodiment the components corresponding to the textual objects 4002a to 4002n are positioned as described previously - - - at a first, third or fourth distance from components corresponding to positioned boundaries above and/or below the objects and following a boundary above and/or below the object. The so positioned components from, and/or along, a boundary or boundaries effectively, visually separate a number, symbol, or operator and/or elements thereof from another a number, symbol, or operator so that a person with a learning difference, such as a dyslexic, can read and understand the text (e.g., equation) based on the components.

The component corresponding to the background section 4003 or another supporting section of the physical device or medium may have a perimeter or edge shaped a circle/oval to correspond to the shape of the image 4001.

When the image 4001 is created using such a physical device or medium it may be necessary to apply one or more elements or parts of the image 4001 to individual components of the physical device or medium.

For example, each of the textual objects (e.g., numbers, symbols, operators) 4002a to 4002n may be individually applied/labeled to a physical component of the physical device or medium (e.g., a number, symbol, operator is applied to a 3D block of wood).

Thereafter, the so labeled component with its corresponding textual object may be inserted onto the surface of the physical device or medium and positioned along one of the positioned non-linear (i.e., curved) boundaries (similar to lines 4004a to 4004n) that have also been formed or positioned on the surface of the physical device or medium (e.g., painted on) or as a raised component so that each component is at a first, third or fourth distance from components corresponding to boundaries above and/or below the objects and following a boundary above and/or below the object as noted previously.

The positioning of the components corresponding to textual objects 4002a to 4002n from, and/or along, a boundary or boundaries and the positioning of the boundaries themselves effectively, visually separates a number, symbol or operator and/or elements thereof so represented from another number, symbol or operator so that a person with a learning difference, such as a dyslexic, can read and understand the text represented based on the components. Each of the components corresponding to textual objects 4002a to 4002n may include means for magnetically attaching the component to the surface 4003.

Referring now to FIGS. 6A to 6C of the DRAWINGS, there is depicted an exemplary example of the conversion of linear formatted text 6000A (e.g., sentences) shown in FIG. 6A into a non-linear formatted dyslexic-friendly readable image 6000B in FIGS. 6B and 6C in accordance with the inventive methods and devices described herein (including, but not limited to, using the types of electronically stored instructions described herein).

Furthermore, with regard to FIGS. 6A-6C, the image 6000b comprises a surface or background portion 6001 comprising one or more positioned non-linear boundaries 6004a-6004n (where “n” represents the last boundary), one or more textual objects 6002a-6002n (where “n” represents the last object), and where the one or more textual objects 6002a-6002n are positioned on the portion 6001 such that each object is at a same first distance from the one or more positioned non-linear boundaries 6004a-6004n, for example.

FIG. 6C depicts another exemplary example of the conversion of linear formatted text (not shown) into a non-linear formatted, dyslexic-friendly readable image 6005 in accordance with the inventive methods and devices described herein (including, but not limited to, using the types of electronically stored instructions described herein), where the image 6005 comprises an excerpt from the well-known book “Alice In Wonderland”.

Though only a small excerpt from that book is shown it should be understood that the entire book in linear formatted text can be converted into inventive non-linear formatted, dyslexic-friendly readable images.

Continuing, image 6005 may comprise a surface or background portion 6006 comprising one or more positioned non-linear boundaries 6007a-6007n (where “n” represents the last boundary), one or more textual objects 6008a-6008n (where “n” represents the last object), and where the one or more textual objects 6008a-6008n are positioned on the portion 6006 such that each object is at a first distance (e.g., same first distance) from the one or more positioned non-linear boundaries 6007a-6007n, for example.

In many of the exemplary embodiments described above the linear formatted images were either in existence (e.g., web site) and then converted into non-linear, dyslexic-friendly readable images or created initially by a user using physical objects (e.g., wood blocks). It should be understood that the inventive methods and devices are not limited to such embodiments. Other variations of the inventive methods and devices may be implemented.

For example, when a person with a learning difference, such as a dyslexic, writes, types or otherwise inputs a symbol (e.g., text) that initially appears in a linear format, for example, using an electronic device (e.g., a keyboard, text-to-image device, whiteboard, touchscreen, mousepad, electronic typewriter, or a device that accepts signatures for example) the so inputted symbol may be converted to a non-linear format using an inventive method that, for example, includes a processor that executes stored instructions for at least (i) receiving the linear formatted symbol, (ii) converting the linear formatted symbol into a non-linear, dyslexic-friendly image that includes at least one non-linear boundary, and (iii) displaying the so-converted symbol. Yet further, if necessary, the reverse may occur as well. That is, an image in an inventive non-linear format may be converted or re-converted into a linear format (as needed) by a processor that executes stored instructions for completing such a function.

When the input is audible (sounds), an inventive method may additionally incorporate speech-to text processes (e.g., stored, executable instructions) for first converting the spoken words or sounds into a form that can be converted in a non-linear, dyslexic-friendly image described herein.

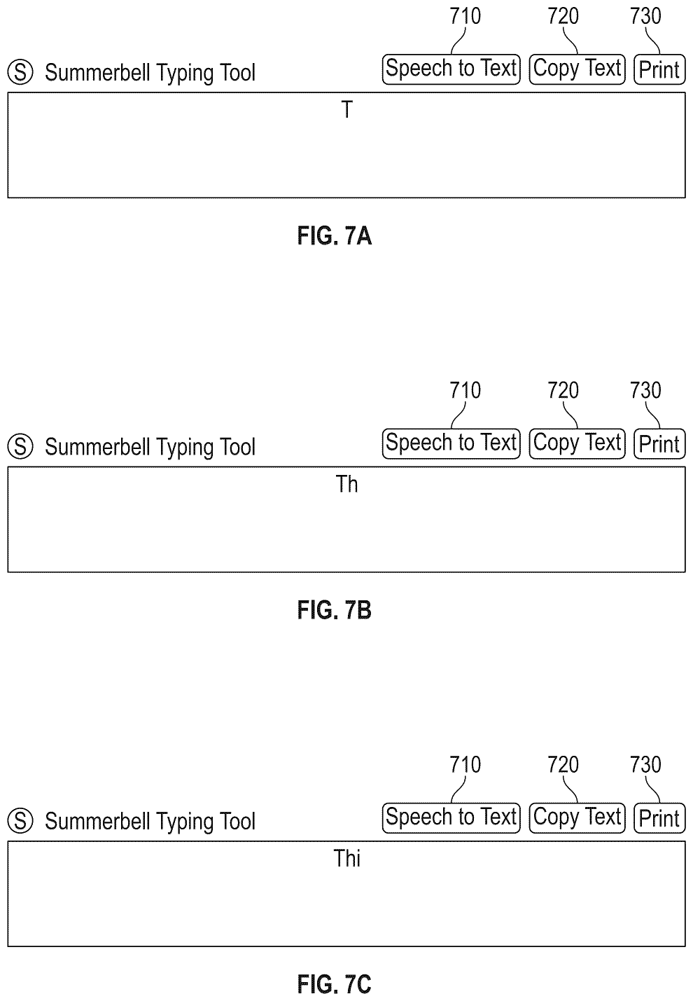

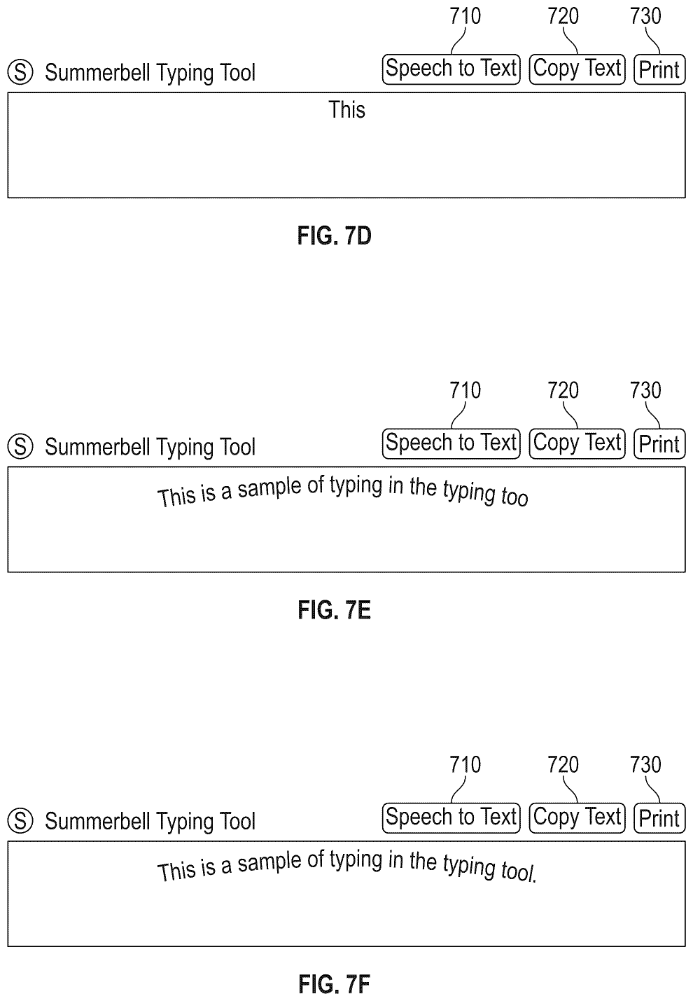

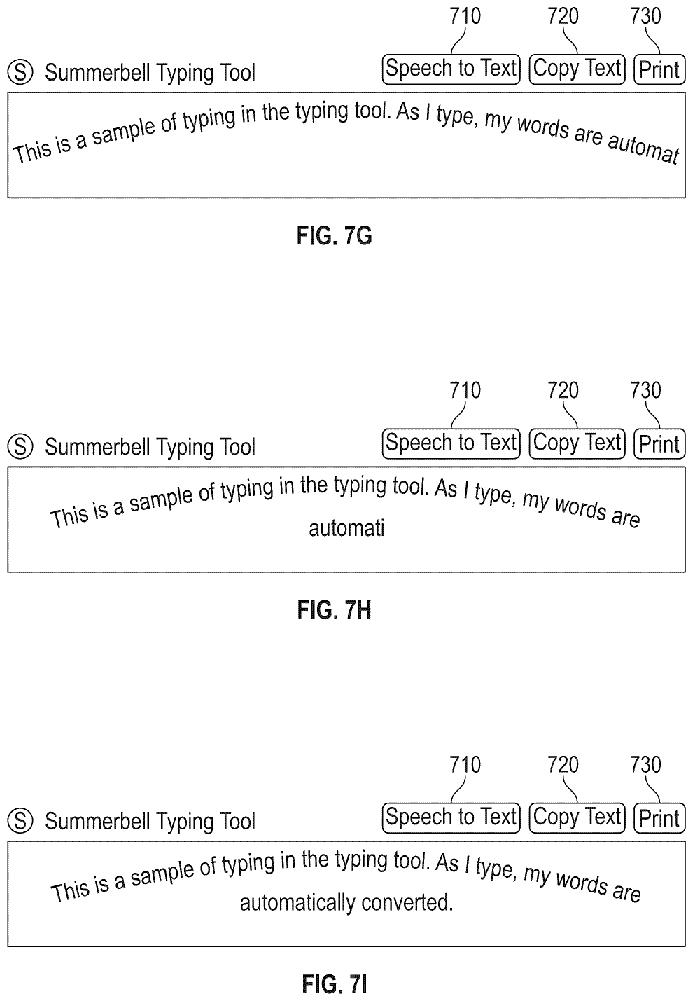

With reference now to FIGS. 7A to 7I of the DRAWINGS, these figures depict illustrative embodiments of a type-to-non-linear text or image methodology according to the invention. In FIG. 7A, a single textual object (e.g., the English language letter “T”) is shown after having been typed into a personal computer (e.g., element 503b in FIG. 5A), for example, and then electronically shown on the computer's display. In an embodiment, a receiver in the computer 503b may be operable to receive signals representing the keys-stroke of the linear formatted letter “T” from a keyboard and then store the signals for processing by a processor in the computer 503b or by a server. Thereafter, the processor may be operable to receive the linear formatted letter object (e.g., letter T) and initially position the letter “T” in substantially the middle of the display.

Further, in embodiments of the invention the processor will additionally position each additional one or more objects (letters, symbols) that are typed into the computer in the correct sequence following the first object (letter) in a grammatical sequence at an initial position that is also in the middle of the display. Thus, as each additional object (letter) is displayed, the processor is operable to position each preceding displayed object (letter) at a position that is farther from the middle of the display (e.g., positioned one space at a time to the left, for example). Yet further, the processor may position each displayed object such that each object is associated with at least one positioned, non-linear boundary as illustrated in FIGS. 7B to 7F. One example of a first line of a sentence that shows letters (objects) positioned from the center of the display outwards and along a non-linear boundary is depicted in FIG. 7F.

As shown in FIGS. 7A to 7F, a processor may be operable to initially position objects along a first non-linear boundary in their proper grammatical sequence. However, the processor may execute instruction stored in memory to determine whether each next object is a last object that can be fit between vertical margins of the display (margins not shown). Upon determining such a last object, (e.g., the letter “e” in the word “are” in FIG. 7G) the processor may be further operable to execute instructions in memory to begin the next line of the sentence consisting of objects (letters) that have been typed into the computer by a user, for example, by initially positioning each object in substantially the middle of the display as shown in FIG. 7H along a next, positioned non-linear boundary (e.g., the boundary under the first boundary). Thus, as each additional line is displayed, the processor may be operable to position the first object (letter) of each subsequent line at a position that is substantially in the middle of the display, along a positioned non-linear boundary.

FIG. 7I depicts two lines of grammatically sequenced letters (objects) along non-linear boundaries that have been positioned as described above after their corresponding linear versions were first typed into a keyboard of a computer, for example.

It should be understood that the images in FIGS. 7A to 7I also include a surface or background portion (not labeled for the sake of clarity), where one or more textual objects (e.g., the letters in each line in FIGS. 7A to 7I) are positioned such that each object is at a first distance (as described previously herein) from its associated, positioned non-linear boundary. Still further, such a first distance may be an equal distance from one or more positioned non-linear boundaries that are located above and/or below the one or more objects, where each of the one or more positioned boundaries is separated by a second distance, and the first distance is substantially ⅓ of the second distance.

It should be understood that the positioning of each letter initially in the middle of the display is merely one method of displaying letters in a non-linear format that have been input (typed) in a computer. Another inventive method positions each letter at an initial position that is not in the middle of the display (e.g., slightly off-center).

The description above focuses on exemplary embodiments for converting linear formatted images and their constituent text, symbols into non-linear, dyslexic-friendly readable images. While certain embodiments have been described it should be understood that the inventive methods and devices are not limited to the described embodiments. Other variations of the inventive methods and devices of the instant invention may be implemented.

As noted hereinabove, the instant invention can be employed in various electronic configurations, such as on a display screen of a personal digital device, smart phone, tablet or other apparatus, as mentioned hereinabove. As such and as discussed, the user may activate an application or app on a display screen of a smartphone or other device to obtain the advantages of the instant invention. With such smaller screens, such as a tablet or smartphone, further or different image manipulation is required.

Just as corrective lenses prescribed from an Optometrist are customized for the needs of a patient, so too is the nature of the Summerbell Reading Method, Applicant's company. In their adaptation of the technology of the instant invention, Applicant has ascertained that there are at least four adjustable settings that impact the comfort and efficacy of the Summerbell Reading Method, i.e., in translating a given linear text onto equivalent arcs, curving the text per the desires of the user.

Based on the aforesaid embodiments set forth hereinabove and the new research, these exemplary settings include (1) Arc Radius or the size of the congruent circles, which subsequently determines how flat or “tight” the resulting arcs will be, as described in more detail hereinabove and further hereinbelow; (2) Line Spacing or the amount of vertical space between subsequent arcs, with various spacings described at length hereinabove; (3) Font Size or the base size of the font to be displayed, which applies directly to body text and is adjusted proportionally up via predetermined multipliers for larger text types, such as headers and sub-headers; and (4) Kerning (Letter Spacing) or the amount of space between each letter, which is typically a positive value, but can be set to near-zero negative figures for a more condensed text display. As dyslexics often have trouble resolving words and phrases, clear demarcations between the letters are preferred, which translates to positive measures. It should be understood that the aforedescribed spacings, useful for the physical and electronic embodiments to make them dyslexic friendly, may be useful here in these newer embodiments, albeit with more dynamism and individualized configurability.

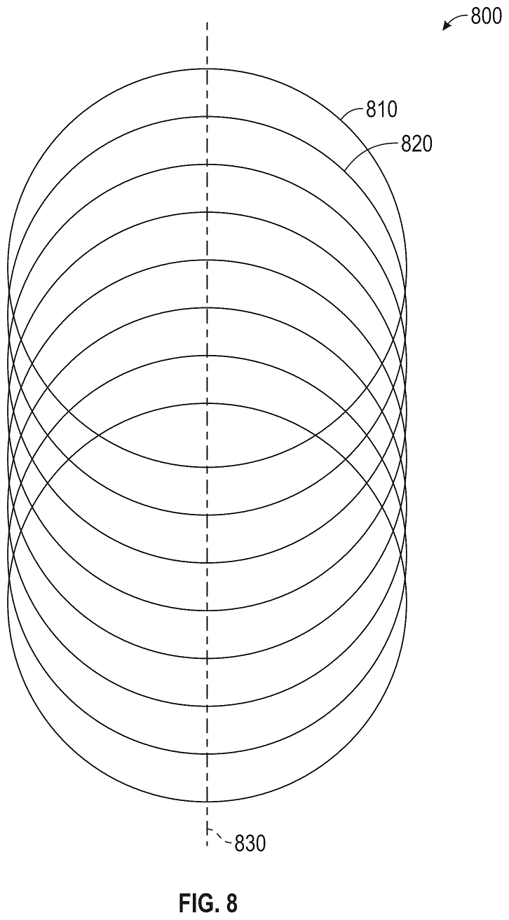

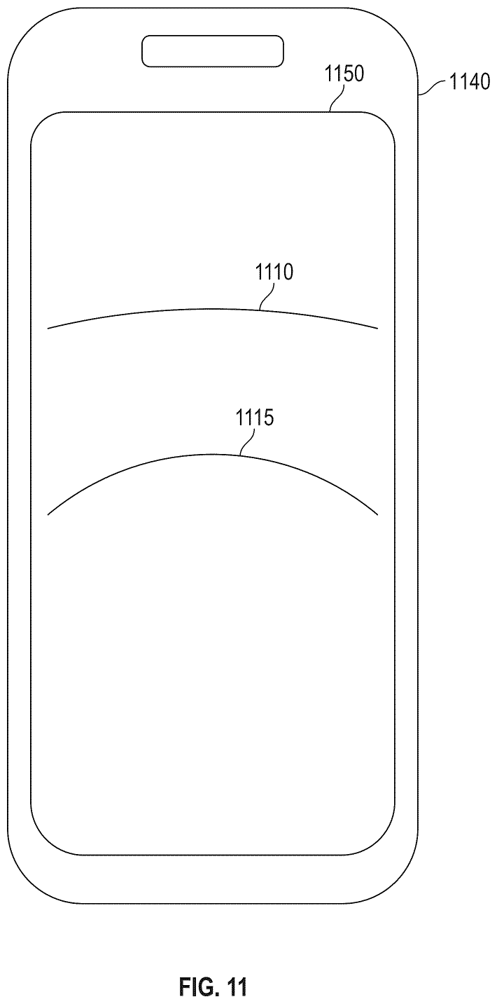

With reference now to FIG. 8 of the DRAWINGS, there is shown an exemplary technique for calculating the lines for use in the instant invention, such as the aforementioned adapting the technique to a smartphone or other portable device, as well as PCs and the like. Before text can be written on arcs, the app (through the computer processors and such) must first calculate the position and the tightness of the arcs. This is done by calculating the position and shape of invisible, congruent circles with the user-defined arc radius, generally designated by the reference numeral 800, which is described in more detail in connection with FIG. 11. Of course, for illustrative purposes, the normally unseen or invisible circles are shown in the figures herein for illustration.

For the arc circle creation and manipulation, an initial circle, generally designated by the reference numeral 810, again, which is normally unseen, is located for use on the viewing device, such as a top line arc for a smartphone, and further congruent circles are calculated to be one line spacing lower than the previous circle, i.e., circle 810 is one line spacing higher than a circle 820, which represents the second line and so forth down the screen page.

It should be understood that all of the circles 800 are centered along a vertical center line, generally designated by the reference numeral 830. In other words, the generated circles are identical in size, radius, diameter, area, etc., with the centers of the respective circles 800 arrayed along line 830, as illustrated in FIG. 8.

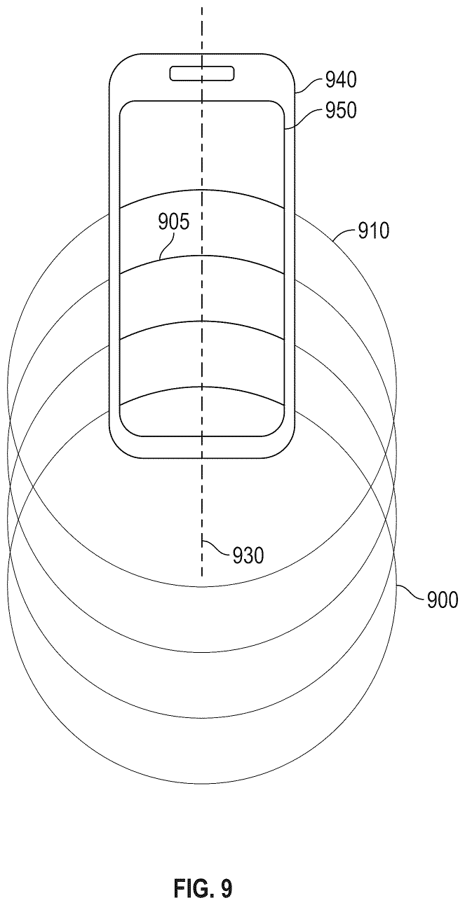

With reference now to FIG. 9 of the DRAWINGS, once the circles 800 have been calculated, i.e., the curved lines to receive the text, the portion of each circle 900 that is on-screen must then be calculated and displayed to determine the amount of text that can fit onto each arc. Again, the arc segments forming the arc lines for the text are a fraction of the circle, hence an arc thereof.

As shown, an apparatus or device or smartphone or tablet, generally designated by the reference numeral 940, with a display 950, shows portions of the circles 900, i.e., the arcs thereof, generally designated by the reference numeral 905, which like the circles 800 are aligned about a centerline 930. As shown, the device 940 is depicted so that the circle 900 segments or arcs 905 on the display 950 are properly oriented and curved, pursuant to the preferences of the user, i.e., the arcs 905 are of a size and orientation chosen by the user to better visualize the curved text placed thereon.

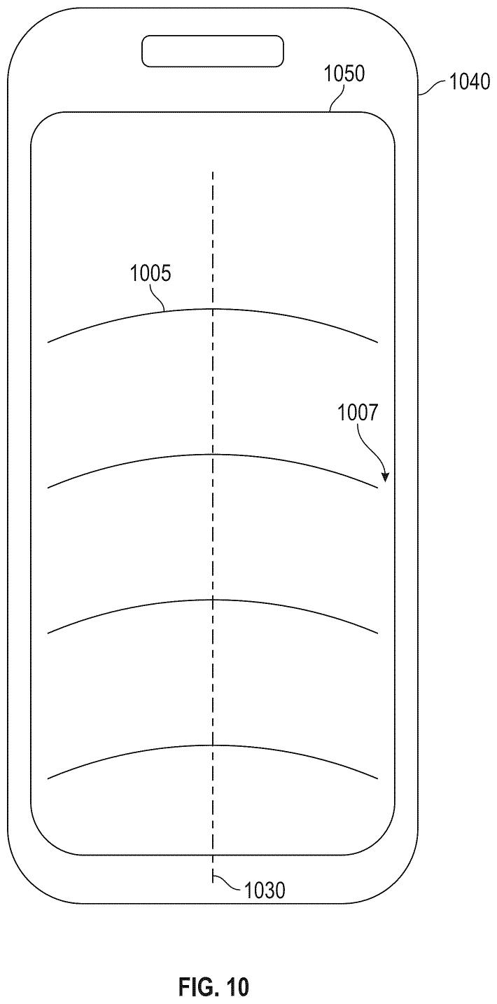

Turning now to FIG. 10 of the DRAWINGS, the device 940 of FIG. 9 is shown, generally designated herein by the reference numeral 1040, with a number of the aforesaid circle arc segments, generally designated by the reference numeral 1005, aligned about a centerline 1030.

Since edge-to-edge text within a display 1050, such as using the arcs 940 in FIG. 9, can be distracting and visually imposing to many users, horizontal and normally hidden margins are normally imposed from the edges of the device display 1050, moving the text away from the device 1040 display edges, further reducing the portion of the arc 1005 available for text to be written on, i.e., shortening the arc length to better facilitate visualization by the user. Indeed, with these margin gaps, generally designated by the reference numeral 1007, on the right and left sides of the display 1050, reading comprehension is improved, e.g., by clearly demarcating the text from the display edges, which helps dyslexics demarcate individual words and letters, as described.

With reference now to FIG. 11 of the DRAWINGS, there is shown an advantage in the operations of the invention, i.e., the aforementioned adjusting the arc radius and other variables to suit the preference of the user. Just as different lens prescriptions are necessary for different human's glasses, so are user settings necessary to maximize the efficacy of the Summerbell Reading Method of the instant invention across a diverse group of dyslexics.

As mentioned, chief among these settings is the ability to adjust the “tightness” of the arc, i.e., the curvatures of the arcs on the display 1140. Some users prefer a wider, flatter arc of the circle segment, generally designated by the reference numeral 1010, representing a large circle, while others prefer a more aggressive, “tighter” arc of the circle segment, generally designated by the reference numeral 1015, representing a smaller circle with a smaller diameter and radius.

Formally, this arc adjustment is achieved by changing the radius of the aforesaid initial circles, as discussed hereinabove. Larger radii result in larger circles, which flattens the curve of the on-screen portion of the arc, as shown by reference numeral 1110. Conversely, shrinking a radius will pronounce the arc visual to the user, as shown by reference numeral 1115.

As discussed, this arc curvature, along with the other parameters, is adjustable by the user. For example, a user observing the screens of FIG. 5G or 5J, may call up the aforesaid indicator 509, as shown in more detail in FIG. 5H, or other menus, i.e., a control box or menu 509, whereby the user can personally adjust their preferences, such as the tightness or flatness of the aforesaid circular arcs for their own viewing pleasure.

Further examples of such controls are described and illustrated hereinbelow, as well as addressed in the various embodiments set forth hereinabove.

As mentioned, text wrapping occurs when the number of characters on a given line exceeds the space capacity for that line. Once the usable arc width has been calculated, e.g., the aforesaid arcs with imposed margins, the text wrapping points are calculated. Wrapping points are the breakpoints in the text where adding further words or letters would cause the line to extend beyond the usable width of the arc.

Wrapping points are calculated by considering five (5) variables: font size, type of text being displayed (title, subtitle, etc.), usable arc width, kerning and the width of the letters in the relevant words.

It should be understood that in a preferred embodiment, the app or APP of the instant invention, as displayed on the displays for devices 503B, 502, 531, 532 with a display or on display 1050/1150 redraws the aforesaid letters and arcs in real-time (typically 60 times per second) as the user scrolls, i.e., dynamically refreshes the screen faster than human perceptibilities. This also prevents the page from needing to translate entire, potentially very large, webpages before displaying text to a user. As such, it is impractical to calculate wrapping on the fly, and it is preferably done so once, before rendering the text.

Once wrapping breakpoints are imposed, the source text is then broken down into a list of small lines of text for character positioning. While each line of text is assured to be no wider than its arc, they may be thinner on a line-by-line basis. In order to center the text on the screen, each line must have its width calculated. Similar to the wrapping breakpoints calculation, the actual width of the text being written is a function of the 5 variables mentioned in more detail hereinbelow.

Each line width is then centered upon the top-most point of the respective arc, an apex or most vertical point, by positioning the first letter of the line to be about ½ of the line width to the left of the top of the arc. From here, each subsequent letter position of the line is calculated to be about 1 kerning distance beyond the width of the previous letter. Once the end of the line is reached, this process is repeated for the next arc.

As mentioned, the first and second distances spacings, described and illustrated in more detail hereinabove are also employed to properly space the lines of text vis-à-vis each other.

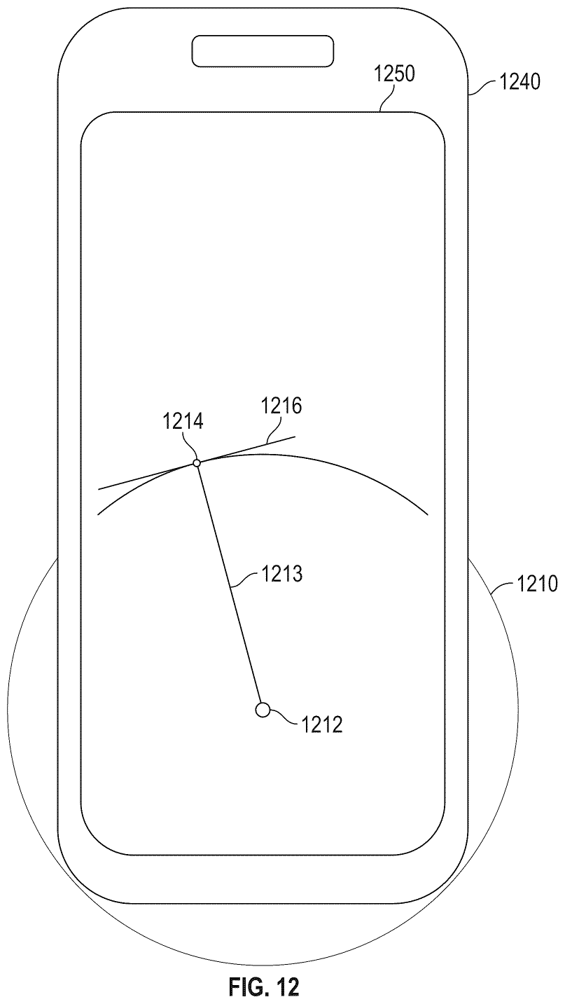

With reference now to FIG. 12 of the DRAWINGS, a methodology to automatically calculate tangents is shown. In this embodiment, once a letter position has been calculated for a given arc, e.g., at reference point 1214 along the circle 1210, the rotation of the letter from normal or vertical orientation must then be determined for proper placement and orientation along that invisible arc line 1210.

Letters are rotated to rest on the tangent line, generally designated by the reference numeral 1216, of the arc at the location of the letter thereon at point 1214, and rendered as such to rest along that respective tangent or that respective letter.

Tangent lines 1216 are calculated by first calculating a straight line, generally designated by the reference numeral 1213, from the desired character point 1214 on the edge of the circle 1210 to the circle's center, generally designated by the reference numeral 1212, i.e., a radius distance of the circle 1210. Then, a tangent line is calculated to rest perpendicularly to the axial line 1213, intersecting it at the circle edge 1214, as shown in FIG. 12, i.e., tangent line 1216.

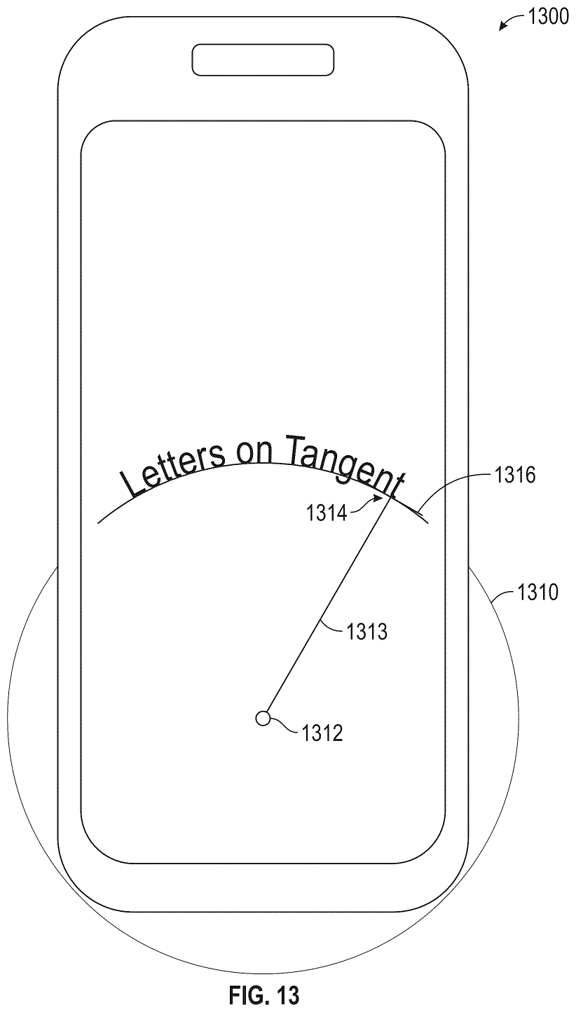

With reference now to FIG. 13 of the DRAWINGS, there is illustrated another embodiment of the instant invention showing an illustrative letter rotation in more detail, generally designated by the reference numeral 1300, with the axial line 1313 from a center 1312 to an arc point 1314, where a tangent line 1316 intersects, which are the relevant orientations for the small “t” shown, which is rendered by the processor and software to be oriented along the circle 1310 arc shown and about that tangent line 1316.

As pictured, this tangent-based rotation causes letters to “lean” left on the first half of the arc and then “lean” to the right on the latter half. A letter drawn in the exact center would appear unrotated, as the tangent line at the top-most point of a circle would be a “flat” line text is traditionally written on.

As discussed, the methodology and the app of the instant invention can convert any text into the format useful for dyslexic readers. For example, as shown and described in more detail in connection with FIGS. 5J and 5K hereinabove, portions of Internet or other posts can be displayed and copied, such as by cutting and pasting with a mouse 533 or fingers on a touch screen 502, 503b, smartphone 531, tablet 532 or the like, and converted. Likewise, images or text or data, stored in memory 504a or 504b can be retrieved and displayed on the display.

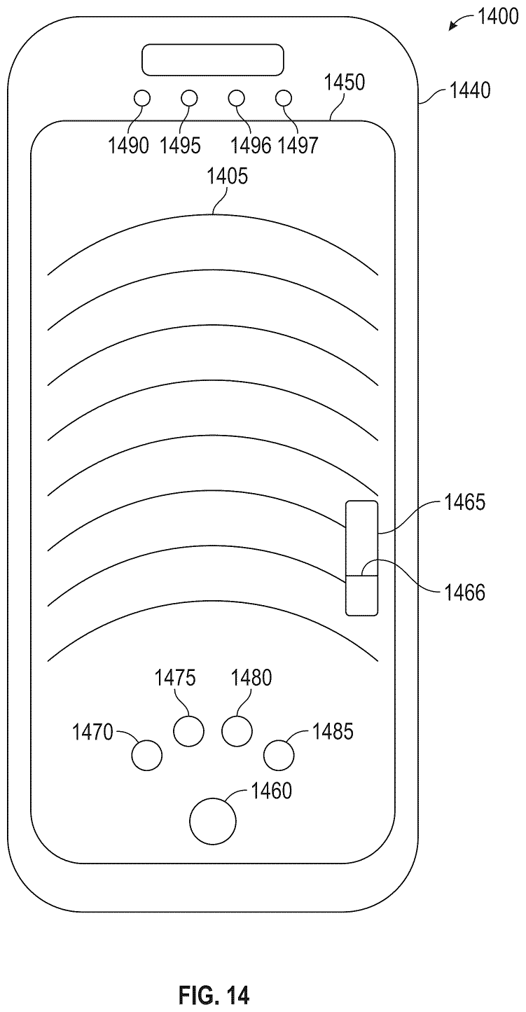

With reference now to FIG. 14 of the DRAWINGS, there is illustrated an exemplary configuration of the instant invention employing the numerous themes and features described in detail hereinabove and illustrated in the figures, generally designated by the reference numeral 1400, in another embodiment of the instant invention.

As shown, a device 1440 with a display screen 1450 has a textual image on the screen, generally designated by the reference numeral 1405, on a surface or background portion. The display 1450 having a number of lines of curved text along a given arc or non-linear boundary, where the text characters are respective textual objects.

In one illustrative embodiment, the device 1440 has a master control button, generally designated by the reference numeral 1460, which may, for example, be placed along the bottom of the aforesaid display 1450.

Clicking, pushing, selecting the master control button, e.g., when a page of normal, linear-based text, such as shown in FIG. 5B, initiates conversion of that linear or flat text into the curved text of the instant invention, as described, along the arcs 1405 with the requisite spacings, which may be configured as defaults. As discussed in more detail hereinbelow, other forms of conversion initiation are contemplated herein, e.g., voice activation. Upon such conversion, a control bar, generally designated by the reference numeral 1465, becomes available.

Also preferably available are various additional icons or buttons for controlling the various parameters of the curved image, as described in more detail hereinabove with the various embodiments.

For example, a text size button, generally designated by the reference numeral 1470, allows the user to adjust the size of the screen text. The user can click, press or select the text size button 1470, indicating the desired function to perform, and the control bar 1465 can also be manipulated to adjust the text size, e.g., by using a cursor or arrow to move or otherwise manipulate a level measure, generally designated by the reference numeral 1466. For example, by moving the level 1466 up, the text size within the image 1405 would increase, and concomitantly, moving the level 1466 down decreases the text size displayed, giving the user control in viewing the image. It should also be understood that the user can alternatively manipulate the control bar using a cursor, their fingers or a pointer device in a touch screen environment.

Likewise, and as discussed, the curvature of the arcs, i.e., the aforesaid flatness and tightness, can be adjusted, e.g., using an arc height button, generally designated by the reference numeral 1475.

As above, activation of this function enables the user to adjust the curvature of the lines of text, i.e., the arcs. For example, moving the level 1466 of the control bar 1465 up could flatten the lines of text, and moving the level 1466 down increase the curvature. Of course, the opposite effect can be employed.

With further reference to FIG. 14, there is shown a letter spacing button, generally designated by the reference numeral 1480. As discussed at length, dyslexics and many others often have trouble discerning breaks between letters, with conjoined letters blurring the text. Here, by activating this function, via letter spacing button 1480, this spacing can be dynamically adjusted, e.g., moving the level 1466 down tightens the inter-letter spacing and moving the level 1466 up increases the spacing.

Furthermore, the line length can be adjusted via a line length button, generally designated by the reference numeral 1485. Just as too tight spacings between words or letters may be a problem, too many words on a line may cause some people trouble. Thus, using line length button 1485, the user can activate this function and manipulate the controls. For example, moving the level 1466 up increases the number of words on a line 1405 and moving the level 1466 down decreases the word count per line.

It should be understood that the line length manipulation here could impact other functions, e.g., the text size, which would dynamically adjust per the manipulations.

Additional functionalities can be included, e.g., a print function, a help function, with a link to a help assistant, a search function to search a term, person, or other information, and displaying results in a curved fashion, examples of which have been described in more detail hereinabove.

The case of use of the instant invention has resulted in usage by various groups to help dyslexics and others having difficulty reading or learning. With young people primarily using smartphones and like devices, the improvements set forth hereinabove can further ameliorate the dyslexic problems in reading linear-based text, whether on a PC display screen or a smartphone screen.

In an exemplary embodiment, the methodology of the instant invention can include the following steps to incorporate text, such as from a webpage:

First, parse the webpage to identify primary text content.

Second, extract the identified raw (HTML) content from the page.

Third, reformat the extracted HTML into for example a JSON (JavaScript Object Notation) format usable outside of a web context.

Fourth, pass the reformatted JSON from the web context to the native app code for translation and presentation.

Fifth, load the user layout settings.

Sixth, for each text block: a. Find the text content of this block; b. Calculate the text size and kerning values for this block based on the user settings and format-specific styles (header vs body text, etc.); and c. For each word in this block: i. Add the word to the current line if doing so will not exceed the available screen width, with margins removed; ii. If adding this word would exceed the available space, instead count the current line as finished, set a wrapping breakpoint before the word in question, and begin a new line with the present word.

Seventh, cut the text up into lines based on the identified wrapping points.

Eight, for each line: a. Draw an arc on screen by calculating a circle centered horizontally on the center of the device and with a radius given by the arcRadius as selected by the user (or the default value); b. Find the left-most point on the arc that is visible onscreen. Save this point to begin calculations as cursorX;

Eight, continued, c. For each character: i. Calculate the position of this character by finding the arc location at the horizontal position given by cursor; ii. Calculate the width of the characters on this line (this is achieved by calculating a bounding rectangle that would exactly encompass the rendered character on screen and then finding the width of the box); iii. If additional characters are present in this line, advance cursorX by:

cursor x=cursor x+charWidth+kerning

Eight, continued, d. Once all characters for a line have been calculated, save the width of this line. e. Calculate the starting position for the line, given by:

cursor x=screenWidth/2−linewidth/2

Eight, continued, f. For each character (again): i. Find the vertical location of the arc for the given cursorX, save this as cursorY; ii. Calculate the angle of the arc for the point at cursorX and cursorY, using:

θ=tan(cursor x, cursor y)

Eight, continued, f. iii. Draw the character on screen at points cursorX and cursorY with the rotation that matches the tangent angle (achieved by counter-rotating the canvas the character is drawn onto).

Note that step 8 and all internal loops are performed both at the initial time of translation and also on a frame-by-frame basis when scrolling. On modern mobile devices, this requires 60+ frames per second to achieve a pleasant experience, which is why all line breaking calculations are done ahead of time to reduce the overhead in the render pipeline.

Ninth, the device presents the calculated screen to the user.

Additional considerations are setting ranges. An exemplary range for settings is as follows:

Kerning: Min-1.5 pixels, Default 0.935 pixels, Max 3.5 pixels.

Line spacing: Min 30 pixels, Default 80 pixels, Max 100 pixels.

Arc Radius: Min 250 pixels, Default 800 pixels, Max 100 pixels.

Base font size: Min 14, Default 18, Max 32.

Additionally, the rendered font size of a given character are based on the user-selected base font size and the format of the text being displayed (header, sub-header, etc.). The base font size is multiplied by a format multiplier to achieve larger-than-selected fonts that scale proportionally to the user selection.

Exemplary font size multipliers are Body multiplier 1. Sub-header 1.2, Header 1.33, Title 1.5, and Syllable (word helper only) 2.

It should be understood that the features described above with respect to one embodiment illustrated by one figure, for example, may also be incorporated into another embodiment described herein and/or shown in a different figure. For the sake of clarity, however, such features have not been repeated for each other embodiment.

Also, it should be understood that for many or all of the embodiments herein, calculations made in connection with the implementing of the instant application can be performed by or augmented by so-called artificial intelligence or AI programs. Also, the instructions for implementing the tools of the instant invention can alternatively be implemented via voice command, such as with the usage of AI. For example, the user of a smartphone 531 having voice command functionality can instruct the computer to perform various actions or initiate the text conversion process.

With AI, many steps can be consolidated and handled by the system. For example, the user of a smartphone can state “Alexa, take the text shown on the screen and convert that text to my preferred format,” where the preferred format is the aforesaid curved lines, with spacings and curvature previously determined by the user. Also, these parameters may be adaptable determined by the particular media involved, e.g., websites are converted pursuant to protocol one, Word documents per protocol two, and so forth, where the various protocols are stored in memory 504a and/or 504b.

It should be understood that the user may tweak a given parameter in the same fashion, e.g., “Alexa, make the curve angle steeper,” or adjust line or character spacings interactively and dynamically, with the adjustment made substantially simultaneously, dependent on computational power. In this fashion, the user can fine tune their perception of the given text to an optimal configuration.

The usage of AI, e.g., in an AI mode, can be indicated by an AI mode indicator/selector, generally designated by the reference numeral 1496, providing a visual cue as to when the AI is on and off.

It should be understood that the AI mode can be initiated by oral command, tactile selection, e.g., using a mouse 533 or a finger, visual cues, received via the aforesaid camera 1495 and other means.

For example, the smartphone 1440 can have a microphone, generally designated by the reference numeral 1490, and a speaker, generally designated by the reference numeral 1497. Similarly, via a camera, generally designated by the reference numeral 1495, visual commands can perhaps be signaled by the user, e.g., for a deaf dyslexic user, gesticulating various commands. Further, the user can command either by typing, selecting, tactile pointing, voice or visual command that the arcs be flattened or tightened, letters be closer or farther, line spacings increase or decrease, line length increase or decrease, make a printout, and any other relevant command to better visualize the text selected.

For example, and as illustrated in the aforementioned FIGS. 7A-7I, the Summerbell Typing Tool illustrated therein not only shows a mechanism for the user to type in the text for arc conversion, as amply demonstrated, but also indicates speech-to-text capability, generally designated by the reference numeral 710, whereby the text may be orally read to the computer microphone 1490 and dynamically converted, such as perhaps using AI functions to facilitate. Additional commands include copying text, generally designated by the reference numeral 720, and print, generally designated by the reference numeral 730.

Numerous changes and modifications to the embodiments disclosed herein may be made without departing from the general spirit of the invention, the scope of which is best defined by the claims that follow.

In view of recent policy changes in the Office, some standard claim terms have come under scrutiny, with a new demand for specificity. In particular, the term “about,” although a relative term, has been in standard use in claims practice for many decades, as an effort to thwart infringers trying to skirt the literal language of the claim. For example, if the claim stated a given dimension as 1-2 inches, an infringer could employ 0.95 inches or 2.05 inches or like close number and assert that they were outside the claim language. Historically, employing the term “about” in this context, e.g., about 1 inch to about 2 inches provided protection, akin to the doctrine of equivalents. Similarly, the term “substantially” is being challenged by the Office on similar grounds, i.e., too vague or indefinite.

As such, the usage of the terms “substantially” and “about” within this Specification and the claims should be given broad but reasonable latitude. Herein, “substantially” and “about” are meant to be within 30 percent of a stated dimension.

The previous descriptions are of preferred embodiments for implementing the invention, and the scope of the invention should not necessarily be limited by these descriptions. It should be understood that various alternatives and equivalents are encompassed herein. The scope of the current invention is defined by the following claims.

We claim:

1. A method for converting linear formatted text into a non-linear, dyslexic-friendly readable text image using an electronic device comprising:
electronically reading or receiving linear formatted text, a user initiating the reading or receiving;
serially converting characters from the linear formatted text into corresponding textual objects, a plurality of said textual objects positioned onto a non-linear, dyslexic-friendly readable text image using an electronic device, where said non-linear, dyslexic-friendly readable text image comprises,
(i) a surface or background portion;
(ii) a plurality of non-linear boundaries disposed on said surface and each aligned about a middle or center part thereof, wherein each said non-linear boundary is a curved line on said surface, each non-linear boundary on said surface having the same non-zero slope and parallel, and
(ii) said plurality of textual objects, created from said linear formatted text and serially disposed on said surface adjacent to given non-linear boundaries, and centered along a given curved line therebetween; and
displaying said textual objects on a display, said plurality of said textual objects centered along said given curved line and between said given non-linear boundaries,
wherein a top part of a given textual object is at a first distance from a first of said given non-linear boundaries positioned on said surface and above said given textual object,
wherein a bottom part of said given textual object is at said first distance from a second of said given non-linear boundaries positioned on said surface and below said given textual object,
wherein said first and second given aligned non-linear boundaries are separated by a second distance, said first distance being substantially one third of said second distance,
wherein said textual objects serially disposed between said given non-linear boundaries along said given curved line, when greater than a line margin, spill over to another given curved line below said given curved line, said another given curved line receiving further serially disposed textual objects, and
wherein said given curved line and said another given curved line are not visible to a user, and said plurality of non-linear boundaries may or may not be visible to the user.

2. The method according to claim 1, further comprising:
adjusting a slope of the non-linear boundaries.

3. The method according to claim 1, further comprising:
electronically selecting one or more textual objects within the non-linear, dyslexic-friendly readable text image;
electronically presenting a list of functional or informative indicators;
electronically selecting an indicator from the list; and
completing a function or displaying information associated with the selected indicator.

4. The method according to claim 3, further comprising:
presenting a definition for said one or more textual objects so selected.

5. The method according to claim 1, further comprising:
electronically selecting one or more textual objects within the non-linear, dyslexic-friendly readable text image; and
emphasizing the one of more selected textual objects.

6. The method according to claim 5, further comprising:
de-emphasizing non-selected textual objects within the non-linear, dyslexic-friendly readable text image.

7. The method according to claim 1, further comprising:
displaying an edit indicator;
selecting a textual object from said plurality of textual objects to be edited; and
editing the textual object.

8. The method as in according to claim 7, further comprising:
visually indicating the selected textual object is being edited by presenting an image editing indicator.

9. The method as in according to claim 7, further comprising:
re-converting the non-linear, dyslexic-friendly text image to the linear formatted text.

10. The method according to claim 1, wherein said plurality of textual objects comprises one or more of grammatical letters, words, numbers, or symbols.

11. The method according to claim 1, wherein a given grammatical letter, word or symbol comprises a character in a language.

12. The method according to claim 1, wherein said reading or receiving is initiated by said user using voice command.

13. The method according to claim 1, wherein the conversion and display of said textual objects is initiated by artificial intelligence.

14. An electronic device operable to convert linear formatted text into a non-linear, dyslexic-friendly readable text image comprising:
an electronic processor operable to execute stored instructions to:
electronically read or receive linear formatted text, a user initiating the reading or receiving;
serially convert said characters from the linear formatted text into corresponding textual objects, a plurality of said textual objects formed into a non-linear, dyslexic-friendly readable text image, where said non-linear, dyslexic-friendly readable text image for display crated by said electronic processor comprises,
a surface or background portion,
a plurality of non-linear boundaries disposed on said surface and each aligned about a middle or center part thereof, wherein each said non-linear boundary on said surface has the same non-zero slope and parallel, and
said plurality of textual objects created from said linear formatted text and serially disposed on said surface are adjacent to given non-linear boundaries, and centered along a given curved line therebetween,
wherein a top part of a given textual object is at a first distance from a first of said given non-linear boundaries positioned on said surface and above said given textual object,
wherein a bottom part of a said given textual object is at said first distance from a second of said given non-linear boundaries positioned on said surface and below said given textual object,
wherein said given aligned non-linear boundaries are separated by a second distance, said first distance being substantially one third of said second distance, and wherein said textual objects serially disposed between said given non-linear boundaries along said given curved line, when greater than a line margin, spill over to another given curved line below said given curved line, said another given curved line receiving further serially disposed textual objects, and
wherein said given curved line and said another given curved line are not visible to a user, and said plurality of non-linear boundaries may or may not be visible to the user.

15. The electronic device according to claim 14, wherein the electronic processor is further operable to execute stored instructions to adjusting a slope of the non-linear boundaries.

16. The electronic device according to claim 14, wherein the electronic processor is further operable to execute stored instructions to:
select one or more textual objects within the non-linear, dyslexic-friendly readable text image;
present a list of functional or informative indicators;
select an indicator from the list; and
complete a function or display information associated with selected indicator.

17. The electronic device according to claim 16, wherein the electronic processor is further operable to execute stored instructions to present a definition of the selected one or more textual objects.

18. The electronic device according to claim 14, wherein the electronic processor is further operable to execute stored instructions to:
select one or more textual objects within the non-linear, dyslexic-friendly readable text image; and
emphasize the one of more selected textual objects.

19. The electronic device according to claim 18, wherein the electronic processor is further operable to execute stored instructions to de-emphasize non-selected textual objects within the non-linear, dyslexic-friendly readable text image.

20. The electronic device according to claim 14, wherein the electronic processor is further operable to execute stored instructions to:
display an edit indicator;
select a textual object from the one or more textual objects to be edited; and
edit the textual object.

21. The electronic device according to claim 20, wherein the electronic processor is further operable to execute stored instructions to visually indicate the selected textual object is being edited by presenting an image editing indicator.

22. The electronic device according to claim 20, wherein the electronic processor is further operable to execute stored instructions to re-convert the non-linear, dyslexic-friendly text image to the linear formatted text.

23. The electronic device according to claim 14, wherein said plurality of textual objects comprises one or more of grammatical letters, words, numbers, or symbols.

24. The electronic device according to claim 23, wherein a given grammatical letter, word or symbol comprises a character in a language.

25. The electronic device according to claim 14, wherein the processor is further operable to position one or more of the textual objects substantially in a middle of a display.

26. The electronic device according to claim 14, wherein said user instructs said electronic processor to convert and display said textual objects using a voice command.

27. The electronic device according to claim 14, wherein said user instructs said electronic processor to convert and display said textual objects using artificial intelligence.

28. A method for creating a dyslexic-friendly image comprising:
receiving a text input, said text input comprising a plurality of linear formatted characters, a user initiating the receiving;
serially converting, by a processor, said linear formatted characters into corresponding character images;
creating a plurality of non-linear boundaries on said display, each aligned about a middle or center part thereof, each said non-linear boundary is a curved line, with each curved line having the same non-zero slope and parallel, and
serially displaying said character images on a display, said character images being centrally aligned on said display between given non-linear boundaries, and centered along a given curved line therebetween, said character images being positioned non-linearly along said given curved line,
wherein a top part of a given textual object is at a first distance from a first of said given non-linear boundaries positioned on said display and above said given textual object,
wherein a bottom part of a said given textual object is at said first distance from a second of said given non-linear boundaries positioned on said surface and below said given textual object,
wherein said textual objects serially disposed between said given non-linear boundaries along said given curved line, when greater than a line margin, spill over to another given curved line below said given curved line, said another given curved line receiving further serially disposed textual objects,
wherein said first and second given aligned non-linear boundaries are separated by a second distance, said first distance being substantially one third of said second distance, and
wherein said given curved line and said another given curved line are not visible to a user, and said plurality of non-linear boundaries may or may not be visible to the user,
whereby said text input is converted to said dyslexic-friendly image.

29. The method according to claim 28, wherein said receiving a text input is initiated by a user using voice command.

30. The method according to claim 28, wherein the conversion and display of said textual objects is initiated by artificial intelligence.

31. A system operable to create a dyslexic-friendly image, comprising:
a receiver, said receiver reading or receiving a text input, said text input comprising a plurality of linear formatted characters, a user initiating the reading or receiving by said receiver;
a processor, said processor serially converting said linear formatted characters into corresponding character images; and
a display, said display having a plurality of non-linear boundaries disposed thereon, each said non-linear boundary aligned about a middle or center part thereof, each non-linear boundary on said display having the same non-zero slope and parallel,
wherein serially created character images are serially disposed on said display, said character images being centrally and non-linearly aligned on a given curved line between given non-linear boundaries, said character images non-linearly positioned along said given curved line such that said character images are at s first distance from said curved line,
wherein a top part of a given textual object is at a first distance from a first of said given non-linear boundaries positioned on said display and above said given textual object,
wherein a bottom part of a said given textual object is at said first distance from a second of said given non-linear boundaries positioned on said surface and below said given textual object,
wherein said textual objects serially disposed between said given non-linear boundaries along said given curved line, when greater than a line margin, spill over to another given curved line below said given curved line, said another given curved line receiving further serially disposed textual objects,
wherein said first and second given aligned non-linear boundaries are separated by a second distance, said first distance being substantially one third of said second distance, and
wherein said given curved line and said another given curved line are not visible to a user, and said plurality of non-linear boundaries may or may not be visible to the user,
whereby said text input is converted to said dyslexic-friendly image.

32. The system according to claim 31, wherein said user instructs said processor to convert and display said textual objects using a voice command.

33. The system according to claim 31, wherein said user instructs said processor to convert and display said textual objects using artificial intelligence.
